(19) United States
(12) Patent Application Publication
(10) Pub. No.: US 2008/0106689 A1
(43) Pub. Date: May 8, 2008

(54) Display Element And Display Device

(76) Inventors: Iichiro Inoue, Mie (JP); Seiji Shibahara, Chiba (JP); Koichi Miyachi, Kyoto (JP); Shoichi Ishihara, Osaka (JP)

Correspondence Address: Nixon & Vanderhye, 901 North Glebe Road, 11th Floor, Arlington, VA, 22203-1808, US

(21) Appl. No.: 10/574,505

(22) PCT Filed: Aug. 24, 2005
(86) PCT No.: PCT/JP05/15315

§ 371 Date: Apr. 26, 2007

(30) Foreign Application Priority Data
Aug. 31, 2004 (JP) 2004-253609

(51) Int. Cl. C09K 19/02

(52) U.S. Cl. 349/181

(57) ABSTRACT

A display element of the present invention includes: a pair of substrates which are opposed to each other; and a substance layer, which is sandwiched between the substrates, exhibiting an optical isotropy when no electric field is applied, while exhibiting an optical anisotropy when an electric field is applied, and the display element performs display operation by applying an electric field to between the substrates. The substance layer includes a liquid crystalline medium exhibiting a nematic liquid crystal phase, and it is Δn×|Δ∈|≧1.9, where Δn is a refractive index anisotropy at 550 nm in a nematic phase of the liquid crystalline medium, and |Δ∈| is an absolute value of a dielectric anisotropy at 1 kHz in the nematic phase of the liquid crystalline medium. The display element and a display device including the display element realize a fast response speed and a low driving voltage and driving in a wide temperature range.

### TECHNICAL FIELD

The present invention relates to a display element and a display device. Particularly, the present invention relates to a display element and a display device both of which is capable of driving at a low voltage and in a wide temperature range and have a wide viewing angle property and high-speed response property.

### BACKGROUND ART

Among various kinds of display elements, a liquid crystal display element has the advantages of being thin, light, and consuming low power. For this reason, the liquid crystal display element has recently come into wide use in display devices incorporated in (i) office automation (OA) equipments such as word processor and personal computer, (ii) information terminals such as video camera, digital camera, and mobile phone, and others. Particularly, a liquid crystal display element using nematic liquid crystal was first used as a display element for numeric segment displays in a clock, an electronic calculator, and others, and has recently come into wide use in a notebook personal computer (PC) and a display for desk top monitor use by taking advantage of being space-saving and consuming low power.

Also, in the television (TV) market used to be monopolized by a cathode ray tube (CRT), liquid crystal display (LCD)-type television, which is a representative of flat panel display (FPD)-type television, is on its way to establishing its strong position in recent years.

Conventionally, as display modes of liquid crystal display elements known are: twisted nematic (TN) mode, which is a liquid crystal display mode of nematic liquid crystal phases (nematic liquid crystal mode); TN mode which achieves optical compensation with a phase difference plate; in-plane switching (IPS) mode; vertical alignment (VA) mode; and optically compensated bend (OCB) mode, for example. Part of liquid crystal display devices using those display modes are already put into commercial production and introduced on the market.

However, all of the aforesaid nematic liquid crystal modes are display modes using the change in orientation of the liquid crystal molecules that exhibit optical anisotropy, obtained by the change in orientation of the liquid crystal molecules that exhibit bulk liquid crystal phases. In other words, in those display modes, liquid crystal molecules are oriented unidirectionally, and bring different views depending upon angles with the liquid crystal molecules form. This makes it impossible to bring a precisely identical image quality depending upon angles at the liquid crystal molecules are viewed and directions from the liquid crystal molecules are viewed.

Additionally, all of the nematic liquid crystal display modes take advantage of the rotation of liquid crystal molecules with the application of an electric field, and require much time for response because the liquid crystal molecules rotate while orienting. On this account, since several tens of milliseconds to several hundreds of milliseconds are unavoidably required for the response of bulk liquid crystal phases, it is difficult to enhance high-speed responsivity to several milliseconds or less.

Consequently, it is desired that (i) such liquid crystal display elements and (ii) liquid crystal display devices including the same liquid crystal display elements further improve response speed (response property) and viewing angle property. Particularly, for further widespread use of LCD-TVs, they are desired to realize (i) high-speed moving picture response performance suitable for moving-picture image displays and (ii) wide viewing angle performance which does not cause change in image and image quality depending upon viewing angles.

Incidentally, in the nematic liquid crystal mode, an orientation regulating force over the surface of the substrate is propagated over the entire bulk inside the cell through self-orientation of the liquid crystal molecules themselves, so that the liquid crystal molecules in the entire bulk are orientated. In other words, in the nematic liquid crystal mode, displays are carried out by using long-range-order realized by the propagation of self-orientation of the liquid crystal molecules themselves.

However, the liquid crystal molecules themselves inherently have a ceiling in improvement of a propagation speed of their self-orientation. For this reason, as far as the nematic liquid crystal display mode is used, it is difficult to realize the high-speed response property and the wide viewing angle property both of which are essential properties for the LCD-TV.

In addition to the liquid crystal display mode of nematic liquid crystal phase, other modes are: (i) ferroelectric liquid crystal (PLC) mode in which smectic liquid crystal phase having a higher degree of ordering than nematic liquid crystal phase exhibit ferroelectricity; and (ii) antiferroelectric liquid crystal (AFLC) mode. Such liquid crystal display modes (smetic liquid crystal modes) inherently exhibit extremely high speed resposivity in microseconds. However, the smetic liquid crystal modes have not yet solved problems such as impact resistance and temperature characteristics and thus have not been developed for commercial use.

Besides, other liquid crystal display mode is: the polymer dispersed liquid crystal (PDLC) mode in which switching between a dispersed state and a transparent state is carried out. The PDLC mode eliminates the need for polarizing plates and enables high-luminance displays. However, the PDLC mode has the problems such as a small difference in contrast between the dispersed state and transparent state and a high driving voltage, and thus have not been developed for commercial use.

The aforesaid display modes take advantage of the rotation of bulk liquid crystal molecules with the application of an electric field. On the contrary, the display mode has been put forth that adopts electronic polarization, taking advantage of the quadratic electro-optical effect.

The electro-optical effects are phenomena in which a refractive index of a material is changed by an external electric field. The electro-optical effects include the effect proportional to the linear electric field and the effect proportional to the square of the electric field. The former is called the Pockels effect and the latter is called the Kerr effect.

Especially, the Kerr effect, which is a quadratic electro-optical effect, has been already adopted in high-speed optical shutters early on, and has been practically used in special measurement instruments.

The Kerr effect was discovered by J. Kerr in 1875. As materials exhibiting the Kerr effect, organic liquids such as nitrobenzene and carbon disulfide are known so far. Those materials are used, for example, in the aforesaid optical shutters, optical modulation elements, polarizing elements, high electric field intensity measurement of power cables or the like, or similar uses.

Afterwards, it was found that liquid crystal materials had a large Kerr constant. Since then, researches on basic technology of liquid crystal materials have been conducted for applications to optical modulation elements and polarizing elements and further its application to optical integrated circuits. It has been reported that some liquid crystal compounds have a Kerr constant more than 200 higher than that of nitrobenzene.

Under such circumstances, studies for using the Kerr effect in display devices have begun. As compared with the Pockels effect proportional to a linear electric field, the Kerr effect is expected to work for a relatively low voltage driving since the Kerr effect is proportional to a square of the electric field. Additionally, the Kerr effect is expected to be applied to fast-response display devices since the Kerr effect inherently exhibits responding property of several microseconds to several milliseconds.

A significant practical problem to be overcome for the utilization of the Kerr effect in display elements is that utilization of the Kerr effect requires a higher driving voltage compared with conventional liquid crystal display elements. To solve such a problem, for example, Japanese Unexamined Patent Application No. 249363/2001 (Tokukai 2001-249363; published on Sep. 14, 2001; hereinafter referred to as Patent document 1) suggests the following technique: In a display element which causes molecules having negative liquid crystallinity to be aligned, the surface of a substrate is subjected in advance to alignment treatment so that the Kerr effect easily exhibits in the display element.

Another big problem in the utilization of the Kerr effect in display elements is a narrower range of temperatures as compared with the conventional liquid crystal display elements. To solve such a problem, for example, Japanese Unexamined Patent Application No. 183937/1999 (Tokukaihei 1999-183937; published on Jul. 9, 1999; counter-part U.S. Pat. No. 6,266,109; hereinafter referred to as Patent document 2) discloses the technique that uses (positive) liquid crystal material having a positive dielectric anisotropy to divide the liquid crystal material into smaller regions, thus solving the temperature dependency of the Kerr effect.

The aforementioned Patent document 1 describes that an alignment film is formed on the substrate and subjected to rubbing or the like alignment treatment to obtain effectively high Kerr constant in isotropic phases, which results in the realization of low-voltage driving.

However, Patent document 1 does not mention a refractive index anisotropy (Δn: the change in refractive index) and dielectric anisotropy (Δ∈) of the liquid crystal material as used, and is totally silent about the use of material having a sufficiently high degree of refractive index anisotropy (Δn) and a sufficiently high absolute value of dielectric anisotropy (Δ∈) as the liquid crystal material.

As such, according to the technique of Patent document 1, even with the alignment film having been subjected to alignment treatment, only molecules existing in the vicinity of the surface of the substrate are oriented, and the area where the Kerr effect easily exhibits is limited to an area in the vicinity of the surface of the substrate. Thus, the technique of Patent document 1 can reduce the driving voltage only by little. This voltage reduction effect is not sufficient by no means in practical use. Further, the technique of Patent Document 1 has a limited temperature range where display is possible, and therefore has not reached the practical level for a display device.

In the technique of Patent document 1, the aforementioned problem results from driving of an isotropic-phase liquid crystal layer.

Specifically, in the conventional liquid crystal displays using the nematic liquid crystal mode, a nematic-phase liquid crystal is driven. In the nematic phase, as described previously, an orientational direction (polar angle and azimuth angle) of liquid crystal molecules over the surface of the substrate is defined by the alignment film having been subjected to alignment treatment in advance over the surface of the substrate. This propagates toward the inside of the cell by virtue of self-alignment performance of the liquid crystal molecules, with the result that molecular orientation can be switched to one orientational direction in the entire bulk liquid crystal layer.

On the contrary, the technique disclosed in Patent document 1 is that a phase subsequent to the nematic phase, i.e. the isotropic phase that exhibits subsequent to the nematic phase when the temperature rises, develops the change in refractive index (Kerr effect), which is proportional to a square of electric field intensity, with application of electric field.

When the temperature rises, the nematic phase of the liquid crystal material transits to the isotropic phase at a certain critical temperature (nematic phase-isotropic phase transition temperature (Tni)) or higher temperatures. In the isotropic phase, like an ordinary liquid, a thermodynamic fluctuation factor (kinetic energy) is larger than the force that acts on the molecules. This allows the molecules to freely move and rotate. In such an isotropic phase, the self-alignment performance that acts among liquid crystal molecules (mutual interaction between molecules) is hardly effective. As such, the alignment treatment over the surface of the substrate does not have much effect on the inside of the cell. Thus, the technique of Patent document 1 can realize the reduction of voltage to some extent, but has not reached a point where it can be developed for commercial use in displays. Further, the aforementioned thermodynamic fluctuation factor (kinetic energy) significantly increases with a temperature rise. Accordingly, a voltage for exhibiting the Kerr effect significantly increases.

Meanwhile, Patent document 2 discloses that the region of liquid crystal material is divided into sub-regions with the use of a specific material so that temperature dependency of the Kerr constant of liquid crystal can be suppressed and further the Kerr constant of a single liquid crystal can be nearly maintained.

However, the liquid crystal material disclosed in Patent document 2 is limited to a liquid crystal material having a positive dielectric anisotropy (positive-type liquid crystal). In addition, it is the precondition that the display element takes a comb electrode structure (i.e. inter-digital electrode structure, horizontal electric field structure) by which an electric field is applied in the substrate in-plane direction.

Examples of Patent document 2 describe the arrangement in which an electric field (vertical electric field) is applied in the normal direction to the substrate. However, the above arrangement merely uses the positive-type liquid crystal material. Further, Patent document 2 discloses the arrangement in which the positive-type liquid crystal material contains a coloring matter and eliminates the polarizing plates, i.e. a guest-host display mode. This is totally fundamentally different from the display mode of the present invention, i.e. the mode of providing a display by exhibiting an optical anisotropy under orthogonal polarizing plates (under crossed nicols).

In the comb electrode structure using a positive liquid crystal material disclosed in Patent Document 2, as in the so-called IPS (In-plane-switching) mode, aperture ratio inevitably decreases by the area where the electrode is provided in a pixel. In order to decrease the voltage for exhibiting the Kerr effect in the isotropic-phase liquid crystal, there is no other choice but to lessen the distance between the comb electrodes. However, in manufacture view, it is almost impossible to lessen the distance between the comb electrodes to the order of not more than 5 μm, for example. As such, in the technique disclosed in Patent Document 2, inherently, it is extremely difficult to reduce an actual driving voltage to a practical voltage range where the conventional TFT (thin-film transistor) element and driver is capable of driving.

In order to increase a driving temperature range even further, Patent Document 2 describes that the aforesaid display element composed of liquid crystal material and electrodes is divided into sub-regions by a polymer network or the like. However, if polymer stabilization is performed although a driving voltage is not reduced prior to the polymer stabilization, the driving voltage increases even further. This inevitably causes the technique of Patent Document 2 to be a long way from being developed for a practical use.

The present invention has been attained in view of the aforementioned known problems, and an object of the present invention is to provide a display element and a display device both of which realizes a high response speed, a low driving voltage, and driving in a wide temperature range.

### DISCLOSURE OF INVENTION

In order to solve the above problem, a display element of the present invention includes: a pair of substrates which are opposed to each other; and a substance layer, e.g. dielectric substance layer, sandwiched between the substrates, the display element performing display operation by applying an electric field to between the substrates, the substance layer including a liquid crystalline medium exhibiting a nematic liquid crystal phase, and exhibiting an optical isotropy when no electric field is applied, while exhibiting an optical anisotropy when an electric field is applied, wherein: Δn×|Δ∈|≧1.9, where Δn is a refractive index anisotropy at 550 nm in a nematic phase of the liquid crystalline medium exhibiting the nematic liquid crystal phase, and |Δ∈| is an absolute value of a dielectric anisotropy at 1 kHz in the nematic phase of the liquid crystalline medium exhibiting the nematic liquid crystal phase.

Further, the display element preferably includes electric field means which produces an electric field between both of the substrates, preferably substantially perpendicularly to the pair of substrates, more preferably perpendicularly to the pair of substrates (i.e. substrate surface normal direction) and applies an electric field to the substance layer. More specifically, the display element is preferably provided with an electrode on each substrate, for applying an electric field between the substrates. With the arrangement in which the electrode is provided on each of the substrates, it is possible to produce an electric field in the substrate surface normal direction to the substrates. In this arrangement in which the electrode causes the electric field to be produced in the substrate surface normal direction to the substrates, the whole area on the substrate can be utilized as the display region, without sacrificing the area where the electrode is provided. This improves aperture ratio and transmittance, and attains reduction of a driving voltage. Further, with this arrangement, it is possible to promote the exhibition of the optical anisotropy not only in the area of the substance layer that is in the vicinity of the substrates but also in the area which is far from the substrates. Moreover, in terms of a gap across which the driving voltage is applied, it is possible to attain a narrower gap compared with the case of attaining a narrow gap between the comb electrodes.

In the present invention, the dielectric substance layer made of the dielectric substance is preferably used for the substance layer, i.e. the layer, as described previously, containing a liquid crystalline medium exhibiting a nematic liquid crystal phase, and exhibiting optical isotropy when no electric field is applied while exhibiting optical anisotropy when an electric field is applied.

Thus, it is more desirable that a display element according to the present invention includes: a pair of substrates which are opposed to each other; a dielectric substance layer sandwiched between the substrates; and electric field applying means for applying an electric field to the dielectric substance layer, the electric field applying means producing an electric filed in a substrate surface normal direction to the substrates, the dielectric substance layer including a liquid crystalline medium exhibiting a nematic liquid crystal phase, and exhibiting an optical isotropy when no electric field is applied, while exhibiting an optical anisotropy when an electric field is applied, wherein: Δn×|Δ∈|≧1.9, where Δn is a refractive index anisotropy at 550 nm in a nematic phase of the liquid crystalline medium exhibiting the nematic liquid crystal phase, and |Δ∈| is an absolute value of a dielectric anisotropy at 1 kHz in the nematic phase of the liquid crystalline medium exhibiting the nematic liquid crystal phase.

Thus, as to the display element which performs display operation by using the substance (medium) exhibiting optical isotropy when no electric field is applied while exhibiting optical anisotropy when an electric filed is applied, particularly the substance (medium) exhibiting optical anisotropy with the change in orientational direction of the molecules when an electric filed is applied, the display element inherently has high-speed response property and wide viewing angle property.

More specifically, with application of an electric field, the display element of the present invention realizes different display states by utilizing the difference in the shape of the refractive index ellipsoid between when no electric field is applied and when an electric field is applied.

The refractive index in substance is not isotropic in general and differs depending on directions. This anisotropy in the refractive index, that is, optical anisotropy of the substance is generally due to the refractive index ellipsoid. In general, it is considered that a plane passing the original point and perpendicular to the traveling direction of the light wave is the cross section of the refractive index ellipsoid with respect to the light traveling in a certain direction. The major axial direction of the ellipsoid is the polarization component direction of the polarized light of the light wave. The half length of the major axis corresponds to the refractive index of that polarization component direction. When the optical anisotropy is discussed in terms of the refractive index ellipsoid, the different display states are realized in a conventional liquid crystal device by changing a major axial direction of the refractive index ellipsoid of a liquid crystal molecule (i.e. by rotating differently) between when an electric field is applied and when no electric field is applied. Here, the shape (shape of cross section of the refractive index ellipsoid) of the refractive index ellipsoid is not changed (constantly ellipsoidal). On the other hand, in the present invention, the different display states are realized by utilizing the difference in the shape (shape of cross section of the refractive index ellipsoid) of the refractive index ellipsoid formed from molecules constituting the medium between when an electric field is applied and when no electric field is applied.

As described above, in the conventional liquid crystal display element, the display operation is carried out by utilizing only the change in the orientational direction of the liquid crystal molecules due to rotation thereof caused by the electric field application. The liquid crystal molecules in alignment are rotated together in one direction. Thus, inherent viscosity of the liquid crystal largely affects responding speed. On the other hand, as in the present invention, the display element which performs display operation by using the medium exhibiting optical anisotropy by application of an electric field, is free from the problem that the inherent viscosity of the liquid crystal largely affects responding speed, unlike the conventional liquid crystal display element. Thus, it is possible to realize high-speed responding. Moreover, as in the present invention, the display element which performs display operation by using the medium exhibiting optical anisotropy by application of an electric field, has high-speed response property, and therefore can be used for a display device of the field sequential color mode, for example.

Moreover, the conventional liquid crystal display element has such a problem that its driving temperature range is limited to temperatures near a phase transition point of a liquid crystal phase, and thus it requires a highly accurate temperature control. On the other hand, the display element which performs display operation by using the medium exhibiting optical anisotropy by application of an electric field, as in the present invention, is only required that the medium be kept at temperatures at which the magnitude of the optical anisotropy changes by the application of the electric field. Thus, it is possible to easily perform the temperature control.

Further, the display element which performs display operation by using the medium exhibiting optical anisotropy by application of an electric field, as in the present invention, carries out display operation by utilizing the change in the magnitude of the optical anisotropy of the medium. Therefore, it is possible to realize a wider viewing angle property than in the conventional liquid crystal display element which performs display operation by changing the orientational direction of liquid crystal molecules.

However, the display element as such has the aforementioned effects, but conventionally has the problem of a very high driving voltage.

On the other hand, according to the present invention, since the liquid crystalline medium in the substance layer (specifically, dielectric substance layer) has a sufficiently large product of the refractive index anisotropy Δn and the absolute value |Δ∈| of the dielectric anisotropy, it possible not only to exhibit the high-speed response property and the wide viewing angle property but also to effectively exhibit optical anisotropy with a lower voltage when an electric field (voltage) is applied, and to realize a wide temperature range.

For example, as to the cell having the comb electrode structure in which an electric field is applied in the substrate in-plane direction as in Patent Document 2, it is the precondition that a liquid crystalline medium having a positive dielectric anisotropy Δ∈ is used. However, the area on the comb electrode is not available for use in display. Thus, aperture ratio decreases correspondingly, and it is difficult to attain a high transmittance. In addition, it is difficult to attain a narrow gap of several μm.

On the contrary, in the present invention, by performing display operation by applying an electric filed to between the pair of substrates, more specifically, with the arrangement in which the electric field applying means is provided so as to produce an electric field in the substrate surface normal direction to the substrates, the whole area on the substrate can be utilized as the display region, without sacrificing the area where the electrode is provided. This improves aperture ratio and transmittance, and attains reduction of a driving voltage. Further, with this arrangement, it is possible to promote the exhibition of the optical anisotropy not only in the area of the dielectric substance layer that is in the vicinity of the substrates but also in the area which is far from the substrates. Moreover, in terms of a gap across which the driving voltage is applied, it is possible to attain a narrower gap compared with the case of attaining a narrow gap between the comb electrodes.

As a result of a study by the inventors of the present application, it was found that in the display element of the present invention driven in an isotropic phase, which is a next phase given subsequent to a nematic phase when the temperature is risen, the liquid crystalline medium obviously shows a property resulting from the refractive index anisotropy Δn and the dielectric anisotropy Δ∈ of the nematic phase when an electric field (voltage) is applied.

When a sufficiently high voltage is applied, the display element can exhibit, at the maximum, an optical anisotropy corresponding to the refractive index anisotropy Δn inherent in the molecules of the liquid crystalline medium in the nematic phase. Thus, it is possible to obtain a display element excellent in light utilization efficiency.

Therefore, in order to exhibit the optical anisotropy with a lower voltage, a larger refractive index anisotropy Δn per molecule increases exhibited retardation. As to an absolute value of the dielectric anisotropy Δ∈, a larger absolute value of the dielectric anisotropy Δ∈ allows the molecules to be oriented in a direction perpendicular to the electric field direction, with a lower voltage, and thus contributes to a low voltage driving.

When the liquid crystalline medium is a liquid crystalline medium satisfying Δn×|Δ∈|≧1.9, as the driving voltage for the display element, a maximum root-means-square value of a voltage applicable to the substance layer, e.g. the dielectric substance layer can be attained with a manufacturable cell thickness (i.e. thickness of the substance layer (dielectric substance layer)).

In order to solve the above problem, the display device of the present invention includes the aforesaid display element according to the present invention.

According to the above arrangement, with the display device of the present invention including the aforesaid display element of the present invention, it is possible to realize a display device which reduces a driving voltage required for display and allows for driving in a wide temperature range. As such, with the above arrangement, it is possible to attain a display device which realizes a high response speed, a low driving voltage, and driving in a wide temperature range.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a graph showing the relation between a voltage value (V₁₀₀(V)) for obtaining the maximum transmittance and a product (Δn×|Δ∈|) of the refractive index anisotropy Δn and the absolute value of the dielectric anisotropy Δ∈, which relation is figured out according to the voltage-transmittance characteristic obtained by measurement of (i) a transparent plate electrode cell having a liquid crystal material according to one embodiment of the present invention sealed therein and (ii) a transparent plate electrode cell having a comparative liquid crystal material sealed therein.

FIG. 2 is a cross sectional view schematically illustrating the structure of a display element according to one embodiment of the present invention.

FIG. 3 is a block diagram schematically illustrating the main part of the display device including the display element according to one embodiment of the present invention.

FIG. 4 is a diagram schematically illustrating the periphery of the display element included in the display device illustrated in FIG. 3.

FIG. 5 is an explanatory view illustrating a relation among alignment treatment directions of alignment films, absorption axis directions of the polarizing plates, and electric field applying directions, in the display element according to one embodiment of the present invention.

FIG. 6(a) is a diagram illustrating orientation of one liquid crystal molecule in the display element illustrated in FIG. 2 when an electric field is applied.

FIG. 6(b) is a diagram illustrating the shape of the refractive index ellipsoid of one liquid crystal molecule, illustrated in FIG. 6(a), when the electric field is applied.

FIG. 7 is a graph showing voltage-transmittance characteristics of a display element according to one embodiment of the present invention.

FIG. 8(a) is a cross-sectional schematic diagram illustrating orientation of liquid crystal molecules in a display element according to one embodiment of the present invention when no electric field is applied.

FIG. 8(b) is a cross-sectional schematic diagram illustrating orientation of liquid crystal molecules in the display element illustrated in FIG. 8(a) when an electric field is applied.

FIG. 9 is a cross sectional view schematically illustrating another structure of a display element according to one embodiment of the present invention.

FIG. 10(a) is a cross sectional view schematically illustrating still another structure of a display element according to one embodiment of the present invention, and a cross sectional view schematically illustrating orientation of liquid crystal molecules in the display element when no electric field is applied.

FIG. 10(b) is a cross sectional view schematically illustrating still another structure of a display element according to one embodiment of the present invention, and a cross sectional view schematically illustrating orientation of liquid crystal molecules in the display element illustrated in FIG. 10(a) when an electric field is applied.

FIG. 11 is a cross sectional view schematically illustrating yet another structure of a display element according to one embodiment of the present invention.

FIG. 12 is an explanatory view illustrating a relation among alignment treatment directions of alignment films, absorption axis directions of the polarizing plates, and electric field applying directions, in the display element illustrated in FIG. 11.

FIG. 13 is a cross sectional view schematically illustrating still another structure of a display element according to one embodiment of the present invention.

FIG. 14 is an explanatory view illustrating a relation between absorption axis directions of the polarizing plates and electric field applying directions, in the display element illustrated in FIG. 13.

FIG. 15 is a cross sectional view schematically illustrating yet another structure of a display element according to one embodiment of the present invention.

FIG. 16(a) is a cross sectional view schematically illustrating yet another structure of a display element according to one embodiment of the present invention, and a cross sectional view schematically illustrating orientation of liquid crystal molecules in the display element when no electric field is applied.

FIG. 16(b) is a cross sectional view schematically illustrating yet another structure of a display element according to one embodiment of the present invention, and a cross sectional view schematically illustrating orientation of liquid crystal molecules in the display element illustrated in FIG. 16(a) when an electric field is applied.

### BEST MODE FOR CARRYING OUT THE INVENTION

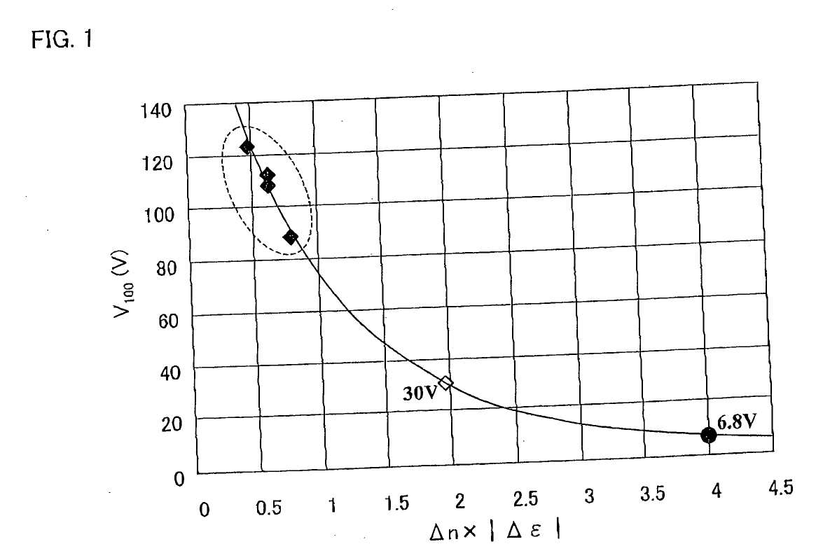

One embodiment of the present invention is described below with reference to FIG. 1 to FIG. 16(a) and FIG. 16(b).

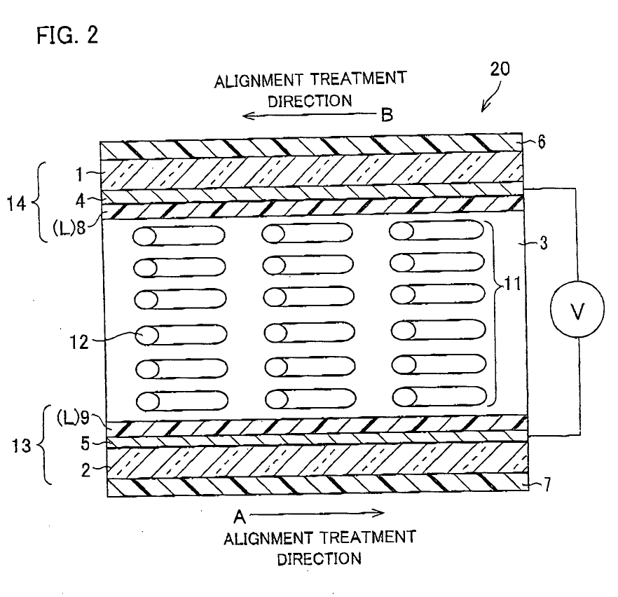

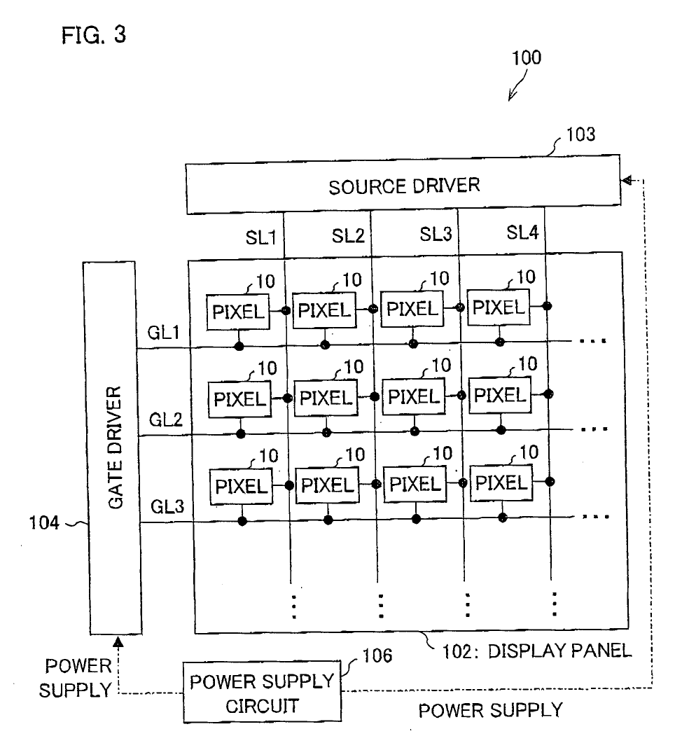

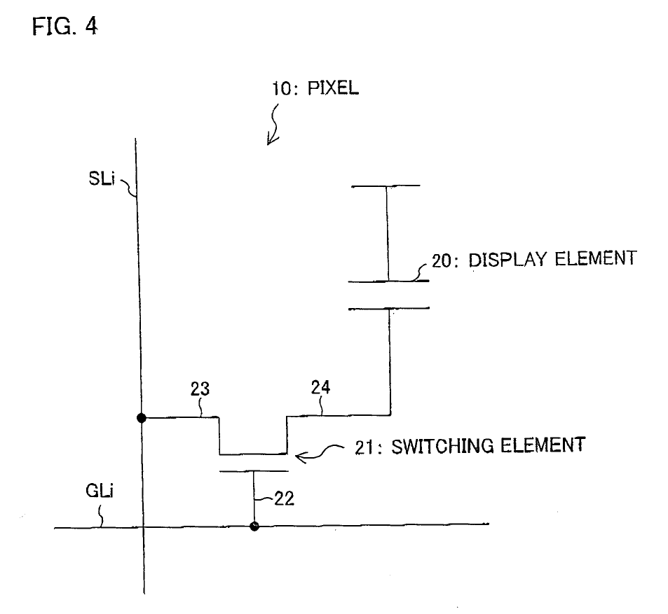

FIG. 2 is a cross-sectional diagram schematically illustrating the structure of a display element according to one embodiment of the present invention. FIG. 3 is a block diagram schematically illustrating the main part of the display device including the display element according to one embodiment of the present invention. FIG. 4 is a diagram schematically illustrating the periphery of the display element included in the display device illustrated in FIG. 3.

For use of a display element according to the present embodiment, the display element is provided in a display device, together with a drive circuit, a signal line (data signal line), a scanning line (scanning signal line), a switching element, and other components.

As illustrated in FIG. 3, a display device 100 according to the present embodiment includes: a display panel 102 having pixels 10 arranged in a matrix manner; a source driver 103 and a gate driver 104 as drive circuits; power supply circuit 106; and others.

As illustrated in FIG. 4, the pixel 10 is provided with a below-mentioned display element 20 according to the present embodiment and a switching element 21.

The display panel 102 further includes a plurality of data signal lines SL1 through SLn (n is any integer which is not less than 2) and a plurality of scanning signal lines GL1 through GLm (m is any integer which is not less than 2) which respectively intersect the data signal lines SL1 through SLn. For each of the combinations of the data signal lines SL1 through SLn and the scanning signal lines GL1 through GLm, the pixel 10 is provide.

The power supply circuit 106 supplies voltages, to the source driver 103 and the gate driver 104, for allowing the display panel 102 to provide displays. This causes the source driver 103 drives data signal lines SL1 through SLn of the display panel 102, and the gate driver 104 drives scanning signal lines GL1 through GLm of the display panel 102.

As the switching element 21, a field effect transistor (PET) element or a thin film transistor (TFT) element is used, for example. The switching element 21 has (i) a gate electrode 22 connected to the scanning signal line GLi, (ii) a source electrode 23 connected to the data signal line SLi, and (iii) a drain electrode 24 connected to the display element 20. The display element 20 has other end connected to common electrode line (not shown) for common use in all of the pixels 10. With this arrangement, in the pixel 10, when the scanning signal line GLi (i is any integer which is not less than 1) is selected, the switching element 21 is brought into conduction, and a signal voltage determined by a display data signal supplied from a controller (not shown) is applied from the source driver 103 to the display element 20 through the data signal line SLi (i is any integer which is not less than 1). On the other hand, while the switching element 21 is interrupted after the selection of the scanning signal line GLi is ended, the display element 20 ideally keeps holding a voltage at the time of the interruption.

In the present embodiment, display operation of the display element 20 is performed by using a medium 11 (substance (dielectric substance); see FIG. 2) that exhibits an optical isotropy (More specifically, isotropic, when viewed macroscopically, specifically, at least isotropic in the visible light wavelength region, that is, in a scale equal to or larger than a wavelength scale of the visible light) when no electric field (voltage) is applied thereon, while exhibiting an optical anisotropy (Particularly, increase in birefringence by application of an electric field is desirable) mainly caused by electronic polarization, orientational polarization, or the like when an electric field (voltage) is applied. The following will describe the structure of the display element 20 according to the present embodiment in detail with reference to FIG. 2.

As illustrated in FIG. 2, the display element 20 according to the present embodiment is arranged such that a dielectric substance layer (dielectric liquid layer; substance layer) 3, which is an optical modulation layer, is sandwiched between a pair of opposed substrates 13 and 14 (electrode substrates) at least one of which is transparent. The substrates 13 and 14, as illustrated in FIG. 2, are arranged so as to include (i) transparent substrates 2 and 1 realized by, for example, glass substrates (transparent substrates), respectively. On the substrates 1 and 2, electrodes 4 and 5 which are electric field applying means for applying an electric field to the dielectric substance layer 3 are provided, respectively, and alignment films 8 and 9 serving as orientation auxiliary material L are provided, respectively. The electrodes 4 and 5 are disposed respectively on the opposed surfaces of the substrates 1 and 2 (i.e. internal surfaces of the substrates 1 and 2). The alignment films 8 and 9 are disposed on the backsides of the electrodes 4 and 5, respectively. On the surfaces (external surfaces) of the substrates 1 and 2 being respectively on the other sides of the substrates 1 and 2 from the opposed surfaces, polarizing plates 6 and 7 are provided, respectively.

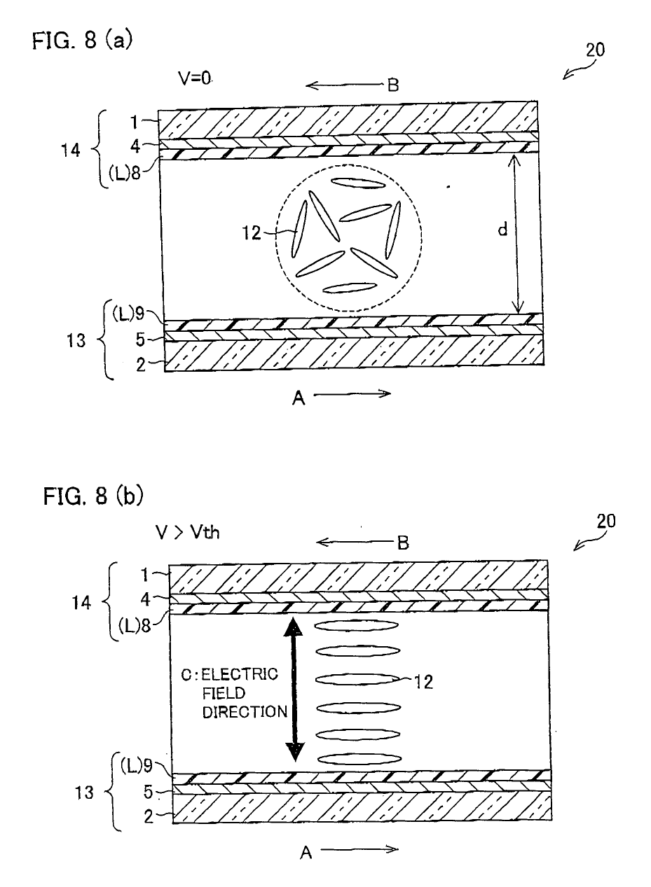

In the present embodiment, a distance d between the substrates 13 and 14 of the display element 20, i.e. thickness of the dielectric substance layer 3 (see FIG. 8(a)) is 1.3 μm. The electrodes 4 and 5 are realized by transparent electrodes made of indium tin oxide (ITO). The alignment films 8 and 9 are realized by horizontal alignment films made of polyimide “JALS-1048 (product name)” manufactured by the JSR Corporation.

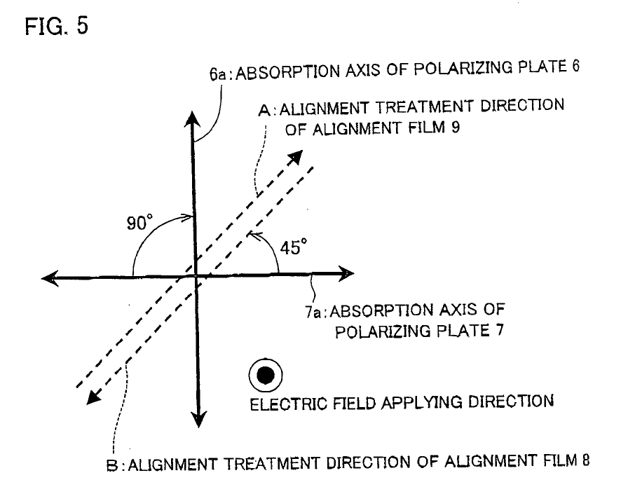

FIG. 5 illustrates a relation among an alignment treatment direction A of the alignment film 8 and an alignment treatment direction B of the alignment film 9, absorption axis directions of the polarizing plates 6 and 7, and directions to which an electric field is applied to the electrodes 4 and 5. The electrodes 4 and 5, as illustrated in FIGS. 2 and 5, are disposed such that an electric field is produced in a substrate surface normal direction to the substrates 1 and 2. The alignment film 8 and 9, as illustrated in FIGS. 2 and 5, are subjected to alignment treatment such as (i) the process of rubbing horizontally to the surfaces of the substrates 1 and 2 (horizontal rubbing treatment) or (ii) light irradiation process (preferably, polarized light irradiation process) so that the alignment treatment directions A and B are antiparalle (i.e. the alignment treatment directions A and B are parallel but opposite to each other). The polarizing plates 6 and 7, as illustrated in FIG. 5, are disposed such that their respective absorption axes 6a and 7a are orthogonal to each other and the absorption axes 6a and 7a of the respective polarizing plates 6 and 7 form an angle of 45° respectively with the alignment treatment directions A and B of the alignment films 8 and 9.

The display element 20 is formed in such a manner that the substrate 13 and the substrate 14 are bonded to each other with a sealing agent (not shown) through a spacer (not shown) such as plastic beads and glass fiber spacer, if necessary, and then the medium 11 is sealed in the space between the substrates 13 and 14.

More specifically, first of all, as illustrated in FIG. 2, the electrodes 4 and 5 are formed on the surface of the substrate 1 and the surface of the substrate 2, respectively. As a method of forming the electrodes 4 and 5, the same method as a method applied to the conventional liquid crystal display element can be adopted.

Then, the alignment film 8 is formed on the substrate 1 so as to cover the electrode 4. The alignment film 9 is formed on the substrate 2 so as to cover the electrode 5. The alignment films 8 and 9 are subjected to alignment treatment such as rubbing treatment or light irradiation process (polarized light irradiation process). In this process, alignment treatment directions of the alignment films 8 and 9 (orientation regulating force directions), e.g. rubbing directions or light irradiation directions (polarized light irradiation directions) are parallel, antiparallel, or orthogonal to each other. For the rubbing treatment, the conventional and common method can be adopted. In the light irradiation process (polarized light irradiation process), for example, the surfaces of the alignment films 8 and 9 are subjected to ultraviolet irradiation (polarized ultraviolet irradiation) in such a manner that irradiated light, preferably polarized light, is parallel, antiparallel, or orthogonal to each other, so that the orientation regulating forces are exerted in the parallel, antiparallel, or orthogonal directions. By using horizontal alignment films as the alignment films 8 and 9 as in the present embodiment, an alignment process closer to rubbing treatment can be carried out. For this reason, it is effective that the aforesaid light irradiation process is a polarized light irradiation process.

Next, the substrates (electrode substrates) 13 and 14 respectively having the alignment films 8 and 9 are adjusted so as to have 1.3 μm spacing (thickness of the dielectric substance layer 3) between them through a spacer (not shown) such as plastic beads, and then bonded with a sealing agent (not shown) provided around the substrates 13 and 14. In the bonding, a part corresponding to an inlet (not shown) for the medium 11 (dielectric substance (dielectric liquid)) to be injected later is left open without being sealed. Materials of the spacer and the sealing agent are not particularly limited, but can be ones used for the conventional liquid crystal display element.

After the substrates 13 and 14 are bonded with each other as described above, the medium 11 is injected between the substrates 13 and 14, which forms the dielectric substance layer 3 made of the medium 11 or including the medium 11.

After the medium 11 is injected into a spacing between the bonded substrates 13 and 14, and then the inlet is sealed to complete a cell, the polarizing plates 6 and 7 are bonded on the bonded substrates 13 and 14 from outside. At this time, the polarizing plates 6 and 7 are bonded in such a manner that the absorption axes 6a and 7a are orthogonal to each other and the absorption axes 6a and 7a of the polarizing plates 6 and 7 form an angle of 45° with the alignment treatment directions A and B of the alignment films 8 and 9.

In a case where light irradiation process, e.g. ultraviolet irradiation (polarized ultraviolet irradiation) is carried out as the alignment process, the substrates 13 and 14 are subjected to ultraviolet irradiation or the like from respective desired directions, and the substrates 13 and 14 are bonded in such a manner that the irradiation directions are parallel, antiparallel, or orthogonal to each other. Then, the medium 11 is injected into a spacing between the substrates 13 and 14, and then the inlet is sealed to complete a cell. Thereafter, the polarizing plates 6 and 7 are bonded on the bonded substrates 13 and 14 from outside.

According to the present embodiment, the dielectric substance layer 3 used in the display element 20 includes, as the medium 11 (dielectric substance), liquid crystalline medium exhibiting nematic liquid crystal phases. In the present embodiment, for the liquid crystalline medium, a negative type liquid crystalline mixture (negative liquid crystal material) having negative dielectric anisotropy (Δ∈) (i.e. negative Δ∈) is used. In FIG. 2, one liquid crystal molecule (one liquid crystalline molecule) of the negative type liquid crystalline mixture 1 making up the medium 11 is shown as a liquid crystal molecule 12.

The negative liquid crystal material, i.e. the liquid crystal material (liquid crystalline medium) having a negative dielectric anisotoropy is a material (medium) realized by liquid crystalline compound in which a liquid crystal phase such as smectic phase or nematic phase as in the present embodiment develops at a low temperature. Also, the negative liquid crystal material is a material (medium) realized by rod-shaped molecules having a dielectric constant in a direction along the long axis of the molecule lower than that in a direction along the short axis of the molecule (dielectric constant in a direction along the long axis of the molecule<dielectric constant in a direction along the short axis of the molecule).

When an electric field is applied to such a liquid crystal material (liquid crystalline medium), each molecule changes its alignment to turns to an in-plane direction of the substrate (i.e. direction parallel to the surfaces of the substrates 1 and 2), as illustrated in FIG. 2, which allows for induction of optical modulations. Thus, the arrangement the liquid crystalline medium having a negative dielectric anisotropy (Δ∈) is used, as described above, allows for more efficient exhibition of optical anisotropy by application of an electric field without loss of aperture ratio, unlike the arrangement in which a substrate in-plane electric field is produced by comb electrodes.

The negative type liquid crystalline mixture can be realized by such as liquid crystal material mixed compound (hereinafter, referred to as liquid crystal material (1)) expressed by, for example, the following Structural Formulas (1) and (2):

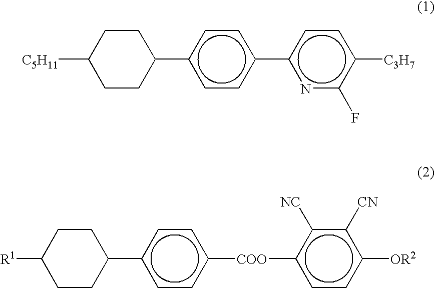

In Structural Formula (2), R¹ and R² are independently an alkyl group having 1 to 7 carbon atoms.

As a result of intense study, the inventors of the present application have found that the arrangement in which the dielectric substance layer 3 includes the medium 11 exhibiting a nematic liquid crystal phase (i.e. the medium 11 realized by a liquid crystalline medium exhibiting a nematic liquid crystal phase, or the medium 11 including a liquid crystalline medium exhibiting the nematic liquid crystal phase), as described above, and exhibits optical isotropy (isotropic phase) when no electric field is applied while exhibiting optical anisotropy by application of an electric field; and refractive index anisotropy (Δn) of the liquid crystalline medium exhibiting the nematic liquid crystal phase in a nematic phase and an absolute value (|Δ∈|) of dielectric anisotropy (Δ∈) are set to be within an appropriate range, enables efficient exhibition of optical anisotropy with a low voltage by application of an electric field and realizes driving in a wide temperature range, which widely opens the door to the commercial use for a display element having high-speed response property.

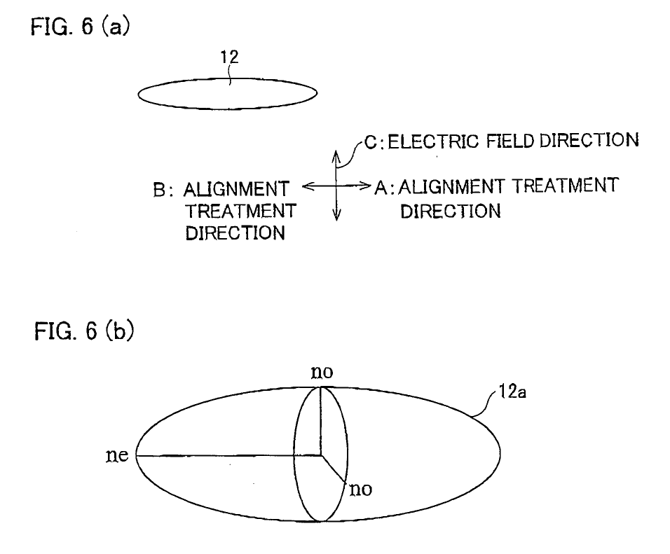

FIG. 6(a) is a schematic view illustrating orientation of one liquid crystal molecule (liquid crystal molecule 12) in the display element 20 illustrated in FIG. 2 when an electric field is applied. Also, FIG. 6(a) illustrates the liquid crystal molecule 12 being oriented in the substrate in-plane direction of the substrates 1 and 2, which is perpendicular to an electric field applying direction indicated by an arrow C. FIG. 6(b) is a schematic view illustrating the shape of the refractive index ellipsoid (refractive index ellipsoid 12a) of one liquid crystal molecule (liquid crystal molecule 12), illustrated in FIG. 6(a), when the electric field is applied. The shape of the refractive index ellipsoid 12a is indicated as a cross section of the refractive index ellipsoid 12a (ellipsoid) taken along a plane passing through an original point and perpendicular to a traveling direction of light wave. The major axis direction of the ellipsoid is a component direction of the polarized light of the light wave, and a half of the length of the major axis corresponds to a refractive index along that direction.

In the present embodiment, as described previously, the medium 11 is nearly optically isotropic (the orientation order parameter≈0 in a scale not smaller than the wavelength of visible light) when no electric field is applied. That is, the medium 11 exhibits an optical isotropy (isotropic phase) when no electric field is applied, while exhibiting an optical anisotropy (inducing optical modulation) when an electric field is applied. As such, the refractive index ellipsoid is spherical when no electric field is applied, that is, the refractive index ellipsoid is optically isotropic when no electric field is applied (orientational order parameter=0). Moreover, the refractive index ellipsoid is optically anisotropic when an electric field is applied (orientational order parameter>0 in the scale not smaller than the wavelength of visible light).

When ne is indicated by a refractive index in the direction perpendicular to the electric field direction C as illustrated in FIG. 6(a), and is a refractive index in a major axis direction of the ellipse (i.e. in the component direction of the polarized light of the light wave) upon application of an electric field, as illustrated FIG. 6(b), due to exhibition of an optical anisotropy, i.e. a refractive index (extraordinary light refractive index) of the liquid crystal molecule 12 in the long axis direction of the refractive index ellipsoid 12a, and no is a refractive index in a direction perpendicular to the major axis direction of the ellipse, i.e. a refractive index (ordinary light refractive index) in the short axis direction of the refractive index ellipsoid 12a of the liquid crystal molecule 12, a refractive index anisotropy (Δn) (birefringence) is expressed by Δn=ne−no.

That is, in the present invention, the refractive index anisotropy (Δn) shows birefringence expressed by Δn=ne−no (ne: extraordinary light refractive index, no: ordinary light refractive index). The present invention has variation in the refractive index anisotropy, whereas the conventional liquid crystal display device has no variation in the refractive index anisotropy.

The long axis direction of the refractive index ellipsoid 12a upon application of an electric field becomes perpendicular to the electric field direction if the medium having a negative dielectric anisotropy is used (however, parallel, if the medium has a positive dielectric anisotropy). On the other hand, the conventional liquid crystal display element provides displays in such a manner that the refractive index ellipsoid is rotated in the long axis direction with application of an electric field. Thus, the long axis direction of the refractive index ellipsoid is not always parallel or perpendicular to the electric field direction.

That is, when the dielectric anisotropy of the dielectric substance is negative (negative type liquid crystal), the major axis direction of the refractive index ellipsoid 12a is perpendicular to the electric field direction (orientational state) regardless of how much electric field is applied. When the dielectric anisotropy of the dielectric material is positive (positive type liquid crystal), the major axis direction of the refractive index ellipsoid 12a is parallel to the electric field direction regardless of how much electric field is applied. In the present embodiment, the electric field application direction and at least one of the major axis directions of the refractive index ellipsoid 12a are parallel or perpendicular to each other always. Note that, in the present embodiment, the orientational order parameter≈0 in the scale not less than the wavelength of visible light indicates that the orientational order parameter is such a state: when the orientational order parameter≈0 in the scale not less than the wavelength of visible light, a majority of the liquid crystal molecules 12 or the like are oriented in a certain direction (there is an orientational order) when observed in a scale smaller than the wavelength of visible light, whereas, in the scale larger than the wavelength of visible light, the orientational directions of the molecules are averaged (that is, random) and there is no orientational order. Therefore, when the orientational order parameter≈0 in the scale not less than the wavelength of visible light, the orientational order parameter is so small that it causes no effect on the light in the wavelength range of the visible light and the light larger than the wavelength of visible light. For example, when the orientational order parameter≈0 in the scale equal to or greater than the wavelength of visible light, the black display is realized under crossed nicols. Furthermore, in the present invention, “the orientational order parameter>0 in the scale equal to or greater than the wavelength of visible light” indicates that the orientational order parameter in the scale equal to or greater than the wavelength of visible light is greater than the orientational order parameter of substantially 0. For example, when the orientational order parameter>0 in the scale equal to or greater than the wavelength of visible light, the white display (and/or gray display, which is a gradation display) is realized under crossed nicols.

Thus, the display element 20 according to the present embodiment carries out a display, for example, by changing the orientation order parameter in the scale not less than the wavelength of visible light while maintaining a constant optical anisotropy direction (without changing the electric field applying direction). The magnitude of the optical anisotropy of the medium 11 itself (e.g. orientational order in the scale not less than the wavelength of visible light) is changed. The display element 20 is therefore significantly different from the conventional liquid crystal display element in terms of display principle.

In the present invention, the change in the magnitude of the optical anisotropy in the medium upon application of an electric field indicates that the shape of the refractive index ellipsoid 12a changes with the application of an electric field. As described previously, in the case that the refractive index ellipsoid 12a exhibits an optical isotropy when no electric filed is applied and then changes the magnitude of the optical anisotropy when an electric field is applied, i.e. in the case that an optical anisotropy exhibits when an electric field is applied, the refractive index ellipsoid 12a changes its shape from a spherical shape to an elliptical shape when an electric field is applied.

The display element 20 of the present embodiment carries out a display by utilizing the distortion occurred in the structure that exhibits an optical isotropy, i.e. changing the magnitude of the optical anisotropy in the medium 11. Because of this, the display element 20 realizes a wider viewing angle property than the liquid crystal display elements in the conventional display mode in which display operation is carried out by changing the orientational direction of the liquid crystal molecules. Further, in the display element 20 of the present embodiment, the birefringence occurs in a constant direction and its magnitude is changeable according to the electric field application. Because of this, the display element 20 realizes a wider viewing angle property than the liquid crystal display elements in the conventional display mode in which display operation is carried out by changing the orientational direction of the liquid crystal molecules.

Moreover, in the display element 20 of the present embodiment, the display operation is carried out by utilizing the anisotropy that is caused by distorting the structure in the micro regions. Because of this, the display element 20 is free from a problem associated with the display principle of the conventional display modes that inherent viscosity of the liquid crystal largely affects the response speed. It is possible to realize high-speed response of about 1 ms in the display element 20. Specifically speaking, because the display principle of the conventional modes utilizes only the change in the orientational direction of the liquid crystal molecules caused by rotation thereof according to the electric field application and the aligned liquid, crystal molecules are rotated together in one direction, the inherent viscosity of the liquid crystal largely affects the response speed. On the contrary, in the display element 20 of the present embodiment, the distortion of the structures in the micro regions is utilized. Therefore, the effect given by the inherent viscosity of the liquid crystal is small and it is possible to attain the high-speed response in the display element 20.

The display element 20 of the present embodiment, in which the above display mode is applied, attains high-speed response. The high-speed response allows the display element to be used, for example, in a display device of the field sequential color mode.

Moreover, the conventional liquid crystal display element has such a problem that its driving temperature range is limited to temperatures near a phase transition point of a liquid crystal phase, and thus it requires a highly accurate temperature control. On the other hand, the display element 20 of the present embodiment only requires that the medium 11 be kept at temperatures at which the magnitude of the optical anisotropy is changeable by the application of the electric field. Thus, it is possible to easily perform the temperature control in the preset invention.

In the present embodiment, the measurement of the refractive index anisotropy Δn was carried out at a wave length of 50 nm by using an Abbe refractometer (“4T (product name)” produced by ATAGO Co., Ltd.).

In the present invention, the dielectric anisotropy (Δ∈) indicates anisotropy of a dielectric constant. The dielectric anisotropy (Δ∈) (variation in dielectric constant) is expressed by Δ∈=∈e−∈o where ∈e is a dielectric constant of the liquid crystal molecule 12 along its major axis, and ∈o is a dielectric constant of the liquid crystal molecule along its minor axis.

The measurement of the dielectric anisotropy Δ∈ was carried out at a frequency of 1 kHz by using an impedance analyzer (“SI1260 (product name)” produced by Toyo Corporation).

Note that, at temperatures except for a temperature extremely near the nematic-isotropic phase transition temperature point (Tₙᵢ) (i.e. at temperatures where the nematic phase is stably exhibited), the nematic phase exhibits comparatively flat values in properties such as the refractive index anisotropy (Δn) and the dielectric anisotropy (Δ∈), relative to temperature. That is, the nematic phase does not have much dependence on temperature. In the present embodiment, the temperature (Tₙᵢ) at which the refractive index anisotropy Δn and dielectric anisotropy Δ∈ are measured is not particularly limited, provided that the medium 11, i.e. the liquid crystalline medium shows the nematic liquid crystal phase at the temperature. However, it is preferable that the Tₖ be in a temperature range of 0.5Tₙᵢ to 0.95Tₙᵢ (i.e. Tₖ is 0.5 to 0.95 times of Tₙᵢ (measurements in kelvins (K)).

In the present embodiment, refractive index anisotropy Δn of the compound of the Structural Formula (1) is 0.155 (measurement was carried out with wavelength of 550 nm at a temperature of 25° (0.89Tₙᵢ)). Dielectric anisotropy Δ∈ thereof is −4.0 (measurement was carried out with frequency of 1 kHz at a temperature of 25° (0.89Tₙᵢ)). Under the same conditions, the dielectric anisotropy Δ∈ of the compound of the Structural Formula (2) is −18. Under the same conditions, refractive index anisotropy Δn of the negative type liquid crystalline mixture (negative-type liquid crystal material), i.e. the liquid crystal material (1) in a nematic phase is 0.14, and the dielectric anisotropy Δ∈ thereof in the nematic phase is −14. That is, in the present embodiment, as the liquid crystal material (1) used is the negative type liquid crystalline mixture (liquid crystal material (1)) prepared by mixing the compounds respectively represented by the Structural Formulae (1) and (2) in such a manner that the refractive index anisotropy Δn of the negative type liquid crystalline mixture (2) in the nematic phase is 0.14, and the dielectric anisotropy Δ∈ of thereof in the nematic phase is −14.

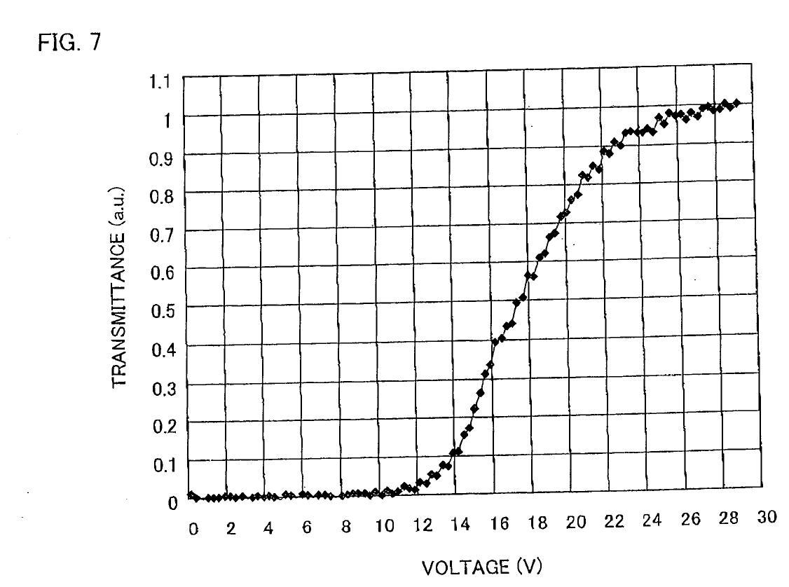

Electro-optical property of the display element 20 thus prepared, which is herein voltage-transmittance characteristics (V-T characteristics), was measured by applying an electric field (voltage) between the electrodes 4 and 5 while the display element 20 being kept at a temperature near above a nematic phase-isotropic phase transition temperature point (Tₙᵢ) (i.e. at a temperature Tₑ which is slightly higher than Tₙᵢ, for example, Tₑ=Tₙᵢ+0.1K) of the liquid crystal material (1) by using an externally provided heating device. Results of the measurement are plotted in FIG. 7. Note that the vertical axis is transmittance (arbitrary unit (a.u.)) and the horizontal axis is an applied voltage (V) in FIG. 7.

As illustrated in FIG. 7, the display element 20 of the present embodiment nearly reaches a maximum transmittance at a relatively low voltage (on the order of 24V), and it is apparent that low-voltage driving is realized by using the aforementioned negative type liquid crystalline mixture (liquid crystal material (1)).

The reason for this is considered as follows. As described above, the negative type liquid crystalline mixture (liquid crystal material (1)) composed of the compounds respectively represented by the Structural Formulae (1) and (2), has relatively large Δn and Δ∈ of 0.14 and −14, respectively, when the refractive index anisotropy in the nematic phase is Δn and the dielectric anisotropy in the nematic phase is Δ∈.

As a result of studying by the inventors of the present application, it was turned out that the display element 20 of the present embodiment carries out driving in the phase next to the nematic phase, i.e. the isotropic phase that exhibits next to the nematic phase when the temperature rises, and when an electric field is applied, shown up are (i) the effect of the orientation regulating force exerted over the surfaces of the alignment films 8 and 9 and (ii) property resulting from the refractive index anisotropy Δn and the dielectric anisotropy Δ∈ of the liquid crystalline medium, i.e. the negative type liquid crystalline mixture in the nematic phase.

The inventors of the present application have inferred a mechanism (workings, principle) of the optical anisotropy exerted in the display element 20 of the present embodiment when an electric field is applied, as follows: That is, since the negative-type liquid crystal material is used as the liquid crystalline medium in the display element 20 of the present embodiment, the liquid crystal molecules 12 in the medium 11 are each oriented in the substrate in-plane direction, i.e. the direction perpendicular to an electric field. Since alignment treatment such as rubbing treatment is performed in antiparallel, the liquid crystal molecules 12 at the interface surfaces with the alignment films 8 and 9 are oriented along the alignment treatment directions B and A, respectively, as illustrated in FIG. 2. The orientation regulating force is also exerted inside the bulk, which realizes a uniaxial orientation. As a result of this, light passes.

The optical anisotropy exhibiting mechanism is illustrated in FIGS. 8(a) and 8(b). FIGS. 8(a) and 8(b) are diagrams illustrating the optical anisotropy exhibiting mechanism in the display element 20 of the present embodiment. FIG. 8(a) is a cross-sectional schematic diagram illustrating orientation of the liquid crystal molecules 12 in the display element 20 when no electric field is applied. FIG. 8(b) is a cross-sectional schematic diagram illustrating orientation of the liquid crystal molecules 12 in the display element 20 illustrated in FIG. 8(a) when an electric field is applied.

In the display element 20, as illustrated in FIG. 8(a), when no electric field (voltage) is applied (V-Q), the dielectric substance layer 3 sandwiched between the substrates 13 and 14 which have respectively provided thereon the electrodes 5 and 4, which are two transparent plate electrodes, exhibits an optical isotropy, and the liquid crystal molecules 12 are oriented randomly. However, as illustrated FIG. 8(b), when an electric field is applied in a substrate normal direction indicated by an arrow C as an electric field direction, i.e. in a normal direction to the substrates 1 and 2 which are components of the substrates 14 and 13, respectively, the liquid crystal molecules 12 in the dielectric substance layer 3 are oriented in the substrate in-plane direction, i.e. the in-plane direction of the substrates 1 and 2, and aligned along the alignment treatment directions A and 3 of the alignment films 8 and 9 under the upper and lower substrates 1 and 2, respectively. As a result of this, when a voltage above a given threshold (Vth) is applied (V>Vth), the liquid crystal molecules 12 are oriented along the alignment treatment directions A and B, and arranged as illustrated in FIG. 5. This allows light to pass.

When a sufficiently high voltage is applied, almost all the liquid crystal molecules 12 in the dielectric substance layer 3 are oriented in the alignment treatment directions A and B.

As such, when a sufficiently high voltage is applied, the display element 20 of the present embodiment can exhibit, at the maximum, an optical anisotropy corresponding to the refractive index anisotropy Δn=ne−no (ne: extraordinary light refractive index, no: ordinary light refractive index) inherent in the liquid crystal molecules 12 (i.e. one liquid crystal molecule) in the nematic phase. Thus, it is possible to obtain a display element which is excellent in light utilization efficiency.

As is seen from this, in order to exhibit the optical anisotropy with a lower voltage, a larger refractive index anisotropy Δn per molecule is preferable for increase in exhibited phase difference (retardation: Δn×d). As to an absolute value of the dielectric anisotropy Δ∈, a larger absolute value of the dielectric anisotropy Δ∈ allows the liquid crystal molecules 12 to be oriented in a direction perpendicular to the electric field direction C, with a lower voltage, and thus contributes to a low voltage driving.

Especially, when the liquid crystalline medium (negative-type liquid crystal material) having the product of the refractive index Δn and the absolute value of the dielectric anisotropy Δ∈ (Δn×|Δ∈|) of 1.9 or larger, preferably, the negative-type liquid crystalline mixture (Δn×|Δ∈|=1.96) was used as the medium 11, the driving voltage of 24V which was set as a first target by the inventors of the present application can be attained with a cell thickness of 1.3 μm (distance between the electrodes in the substrate normal direction, more specifically, thickness of the dielectric substance layer 3: d), which is manufacturable.

The reason why the driving voltage of 24V was considered as a first target by the inventors of the present application was as follows.

A maximum withstand voltage applicable to the gate electrode of a TFT element as the switching element 21 with optimal film thickness and film material of the gate electrode is 63V Here, a voltage (1) attained when a potential of the gate electrode is High (that is, the gate electrode is ON) is 10V. A voltage (2) attained when a potential of the gate electrode is LOW (that is, the gate electrode is OFF) is −5V. A maximum voltage applicable to the dielectric substance layer 3 is 48Vpp, which is obtained by subtracting a peak-to-peak voltage of (1) and (2) from the maximum voltage of 63V (63−10−5=48Vpp (peak-to-peak)). This voltage value is ±24V in terms of rms value (root-mean-square). This voltage value is the first target aimed for by the inventors of the present application.

In the display element 20 of the present embodiment, as described previously, it is the precondition to have a structure in which transparent plate electrodes (electrodes 4 and 5) which apply a vertical electric field, i.e. an electric field in the normal direction to the substrates are used (vertical electric field structure).

On the contrary, in the display element of the conventional technique described in Patent Document 2, it is the precondition to have the comb electrode structure (i.e. inter-digital electrode structure, horizontal electric field structure) by which an electric field is applied in the substance in-plane direction.

The following will show a crucial difference between the vertical electric field, structure as in the display element 20 according to the present embodiment and the horizontal electric field structure as in the conventional technique.

In the comb electrode structure, it is the precondition that a positive liquid crystal material (positive liquid crystalline medium) having a positive dielectric anisotropy Δ∈ is used. However, the area on the comb electrode is not available for use in display, and the aperture ratio decreases correspondingly. It is therefore difficult to obtain a high transmittance. In order to decrease a driving voltage in the comb electrode structure, there is no other choice but to lessen the distance between the comb electrodes. However, in consideration of limits on manufacturing accuracy, process margin, process cost etc., it is difficult to attain a narrow gap of several μm.

On the contrary, in the vertical electric field structure as in the display element 20 according to the present embodiment, it is assumed to use a negative liquid crystal material, and transparent flat electrodes like the electrodes 4 and 5 can be used. On this account, in the display element 20 as such, the whole area on the substrates 13 and 14 can be utilized as the display region. This realizes a display element having a high aperture ratio and a high transmittance. Moreover, in terms of a gap across which the driving voltage is applied, it is relatively easy to reduce the cell thickness (d) in manufacture view, compared with the case of attaining a narrow gap between the comb electrodes. It is possible to attain a narrow gap of the order of 1 μm at the minimum.

Next, the following will describe the result of the experiment using (i) the liquid crystal material (1), i.e. the foregoing negative-type liquid crystalline mixture and (ii) several liquid crystal materials that had been studied before the liquid crystal material (1) was found.

First of all, as to (i) the foregoing liquid crystal material (1) used in the present embodiment and (ii) comparative liquid crystal materials (1) through (4), i.e. the liquid crystal materials that had been studied before the liquid crystal material (1) was found and respectively represented by the following Structural Formulae (3) through (6),

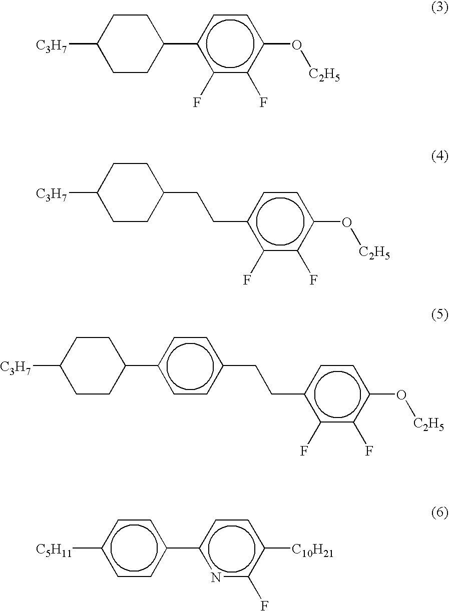

values in properties (Δn: refractive index anisotropy, Δ∈: dielectric anisotropy, and Δn×|Δ∈|) were measured. The result of the measurement is shown in Table 1. The measurements of the refractive index anisotropy Δn and dielectric anisotropy Δ∈ were carried out under the aforementioned conditions.

TABLE 1

| | Δn | Δε | Δn × \|Δε\| |
|---|---|---|---|
| LIQUID CRYSTAL MATERIAL (1) | 0.14 | −14 | 1.96 |
| COMPARATIVE LIQUID CRYSTAL | 0.1101 | −7.2 | 0.79 |
| MATERIAL (1) | | | |
| COMPARATIVE LIQUID CRYSTAL | 0.1098 | −5.7 | 0.63 |
| MATERIAL (2) | | | |
| COMPARATIVE LIQUID CRYSTAL | 0.1280 | −4.9 | 0.63 |
| MATERIAL (3) | | | |
| COMPARATIVE LIQUID CRYSTAL | 0.1107 | −4.3 | 0.48 |
| MATERIAL (4) | | | |

Then, these liquid crystal materials were sealed in respective transparent plate electrode cells (vertical electric field cells) similar to the display element 20 of the present embodiment, and voltage-transmittance characteristics (V-T characteristics) was measured in a similar manner to the measurement illustrated in FIG. 7 while the transparent plate electrode cells being kept at a temperature Tₑ near above a nematic phase-isotropic phase transition temperature point (Tₙᵢ) (i.e. at a temperature Tₑ which is slightly higher than Tₙᵢ, T==Tₙᵢ+0.1K) of the liquid crystal materials by using an externally provided heating device. The cell thickness (d) of the transparent plate electrode cells was all 1.3 μm.

From the thus obtained voltage-transmittance characteristics curve, estimated was relationship between the voltage (V₁₀₀(V)) to attain a maximum transmittance and the product (Δn×|Δ∈|) of these measured refractive index anisotropy Δn and absolute value of dielectric anisotropy Δ∈. This relationship is plotted in FIG. 1 where the vertical axis is V₁₀₀(V) and the horizontal axis is Δn×∈Δ∈|, and “♦” represents the comparative liquid crystal materials (1) through (4), and “⋄” represents the liquid crystal material (1) of the present embodiment.

As illustrated in FIG. 1, the driving voltage V₁₀₀ (V) is largely correlated with the new parameter Δn×|Δ∈|. It is deduced that the driving voltage V₁₀₀ (V) follows a certain curve. Larger refractive index anisotropy Δn and larger absolute value |Δ∈| of dielectric anisotropy Δ∈ contribute to lower-voltage driving. This curve was extrapolated for realization of further lower-voltage driving. For example, when Δn×|Δ∈| is 4, V₁₀₀ (V) is approximately 6.8V represented by “” in FIG. 1. This voltage is within such a voltage range that driving can be performed using the conventional TFT elements and general-use drivers, and is within a numerical range practically feasible without cost increase for drivers and the like.

The liquid crystal material having Δn×|Δ∈| of 4 can be realized, for example, by a liquid crystal material having a refractive index anisotropy Δn of 0.20 and a dielectric anisotropy Δ∈ of −20 in the nematic phase. In general, it is said that it is very difficult to increase only the refractive index anisotropy Δn, or only the dielectric anisotropy Δ∈. As a result of intensive studies, the inventors of the present application came to the conclusion that, in order to attain Δn×|Δ∈|≧4 with a good balance between the refractive index anisotropy Δn and the dielectric anisotropy Δ∈, it is preferable that Δn≧0.20 and |Δ∈|≧20. Such a negative-type liquid crystal material can be realized by a mixture or the like of compounds (liquid crystal materials) respectively represented by the following Structural Formulae (7) and (8):

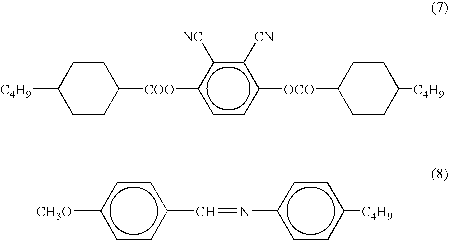

Note that both of the compounds represented respectively by the Structural Formula (7) and the Structural Formula (8) have the refractive index anisotropy Δn which satisfies the aforementioned conditions (Δn≧0.20, |Δ∈|≧20).

In the above explanation, the cell thickness (d) is fixed to 1.3 μm in setting the numerical ranges of the parameters of the liquid crystal material. If the cell thickness is thicker than 1.3 μm, a higher driving voltage will be inevitably required. Thus, if the cell thickness (d) is thicker than 1.3 μm, larger Δn×|Δ∈| is necessary. Thus, the parameters will be within the numerical ranges of the present invention consequently.

Next, a case of the cell thickness (d) thinner than 1.3 μm will be discussed. Current production processes allows a display element to come down in cell thickness to the order of 1 μm. Therefore, it is expected that no problem will arise if the calculation is based on the cell thickness (d) of 1.3 μm. However, it cannot be said that a cell thickness less than 1 μm will not be realized as a result of future improvement of the production processes. The inventors of the present application have come to the conclusion that even if such the cell thickness (d) of less than 1 μm is realized, no problem will arise when it is Δn×|Δ∈|≧1.9, preferably Δn×|Δ∈|≧1.96 as a lower limit for the parameter that the liquid crystal material should satisfy in order to realize a display element with no increase in cost by using the multi-purpose TFT element and driver.

As described above, the temperature (Tₖ) at which the refractive index anisotropy Δn and dielectric anisotropy Δ∈ are measured is not particularly limited, provided that the liquid crystal material, that is, the liquid crystalline medium, shows the nematic liquid crystal phase at the temperature. However, it is preferable that the Tₖ be in a temperature range of 0.5Tₙᵢ to 0.95Tₙᵢ. That is, in the present embodiment, the liquid crystal material should be such that Δn×|Δ∈| is not less than 1.9, where Δn×|Δ∈| is the product of the refractive index anisotropy Δn measured with 550 nm and the absolute value |Δ∈| of the dielectric anisotropy measured with 1 kHz when the material is in the nematic phase. It is more preferable that Δn×|Δ∈| be not less than 1.9, where Δn×|Δ∈| is the product of the refractive index Δn measured with 550 nm and at a temperature in the range of 0.5Tₙᵢ to 0.95Tₙᵢ, and the absolute value |Δ∈| of the dielectric anisotropy at 1 kHz and at a temperature in the range of 0.5Tₙᵢ to 0.95 Tₙᵢ when the material is in the nematic phase.

In the present embodiment, the larger parameter Δn×|Δ∈| is preferable for attaining the low-voltage driving. However, the multi-purpose TFT elements, driving circuits, and ICs (integrated circuits) are uneven (has dispersion) in terms of voltage value. Thus, if the driving voltage was as small as the dispersion of the voltage value, there would be a case that the gray level display cannot be performed sufficiently. The dispersion of the voltage value is estimated as about 0.2V at maximum. Hence, the larger parameter Δn×|Δ∈| is preferable. In order to realize a display element with no cost increase by using the multi-purpose TFT element, driving circuit, and IC, it is preferable that the applied voltage V₁₀₀ (V) be larger than the dispersion of the voltage value. It is expected that stable gray level display can be attained by setting the applied voltage V₁₀₀ (V) larger than the maximum dispersion of the voltage value, that is, 0.2V. Extrapolation from the curve of FIG. 1 where the cell thickness (d) is fixed to 1.3 μm, tells that it is preferable that the parameter Δn×|Δ∈| be 24 or less (that is 1.9≧Δn×|Δ∈|≦24, especially 4≦Δn×|Δ∈|≦24), and it is more preferable that that the parameter Δn×|Δ∈| be 20 or less (that is 1.9≦Δn×|Δ∈|≦20, especially 4: Δn×|Δ∈|≦20).

In the above discussion, preferable parameter ranges are set with regard to only the refractive index anisotropy Δn and dielectric anisotropy Δn of the liquid crystal material. However, contributory factors to determine the electro-optical property (e.g. voltage-transmittance characteristics) is not only the values in properties of the liquid crystal material but also the cell thickness (d). That is, as described previously, phase difference (retardation) is determined by the following equation: Δn×d, and this corresponds to transmittance.

As described previously, the display element 20 of the present embodiment, illustrated in FIGS. 2 and 5, has a cell such that the alignment treatment directions (e.g. rubbing directions) are anti-parallel to each other. In the so-called Electrically Controlled Birefringence (ECB) type display element where the alignment treatment directions are parallel or antiparallel to each other, i.e. in the parallel alignment mode, maximum light utilization efficiency (i.e. maximum transmittance) is attained within numerical range of λ/4≦Δn×d≦3λ/4 where half-wave length condition (λ/2 condition; more specifically, λ/2=275 nm when λ=500 nm) is at the center. Numerically, 137.5 (nm)≦Δn×d≦412.5 (nm) is preferable. More preferably, 175 (nm)≦Δn×d≦375 (nm). In the arrangement where the alignment treatment directions are orthogonal to each other, i.e. in the 90° twist alignment mode (so-called TN mode), a maximum light utilization efficiency is attained in the range of 350 (nm)≦Δn×d≦650 (nm). According to the present embodiment, it is possible to improve light utilization efficiency by satisfying the above conditions. In the aforementioned equations, λ is wavelength (nm) of incident light (visible light), i.e. observation wavelength (nm), and d is the cell thickness (μm), i.e. a thickness of the dielectric substance layer 3.

Note that the above-specified values relate to the phase difference (Δn×d) which is caused in a temperature range where the isotropic phase exhibits. It is desired that the refractive index anisotropy Δn in the above-specified values is the one at a temperature near the temperature where the isotropic phase is exhibited wherever possible. As described previously, in calculating the phase difference (Δn×d), the refractive index anisotropy Δn is a value measured at a wavelength of 50 nm in the nematic phase, preferably a value measured at a temperature near the temperature where the isotropic phase is exhibited wherever possible (from a safety standpoint, Tₖ(K)=Tₙᵢ(K)−5(K)).

As described above, in the present embodiment, by way of taking an example described was mainly the display element 20 in which the alignment films 8 and 9 (horizontal alignment films) are provided respectively on the inner surfaces of the electrodes 4 and 5, i.e. on the opposing sides of the substrates 14 and 13, wherein the alignment films 8 and 9 have been subjected to alignment treatment, such as rubbing treatment or light irradiation treatment (preferably polarized light irradiation treatment), horizontal with respect to the substrate surfaces of the substrates 1 and 2 in such a manner that the alignment treatment directions B and A are antiparallel to each other. However, the present invention is not limited to the above arrangement.

That is, in the display element 20, as the orientation auxiliary material L for promoting the exhibition of optical anisotropy with application of an electric field (i.e. orientation change of the medium 11 with application of an electric field), for example, at least one of the alignment films 8 and 9 serving as the horizontal alignment films are provided in at least one of the pair of the substrates 13 and 14. Preferably, both of the alignment films 8 and 9 are provided respectively in the substrates 14 and 13. This allows orientational direction of the liquid crystal molecules 12 in the vicinities of the surfaces of the horizontal alignment films in the dielectric substance layer 3 to be fixed to the substrate in-plane direction. With this arrangement, in the state where the liquid crystalline medium is caused to exhibit the liquid crystal phase, i.e. nematic liquid crystal phase, the liquid crystal molecules 12 making up the liquid crystalline medium can be oriented in the substrate in-plane direction. Thus, the orientation auxiliary material L can be provided in such a manner that a high proportion of the liquid crystal molecules 12 are oriented along the substrate in-plane direction. With this arrangement, the orientation auxiliary material L promotes the liquid crystal molecules 12 making up the liquid crystalline medium to be oriented in the substrate in-plane direction when an electric field is applied. As such, it is possible to reliably and efficiently promote the exhibition of an optical anisotropy when an electric field is applied. Especially, the horizontal alignment films are preferable to attain the object of the present invention of by using the liquid crystalline medium having a negative Δ∈ (dielectric anisotropy), causing the liquid crystal molecules 12 to be oriented in the substrate in-plane direction when an electric field is applied. Unlike the vertical alignment films, the horizontal alignment films allows the liquid crystal molecules 12 to be efficiently oriented in the substrate in-plane direction when an electric field is applied, thus causing the liquid crystal molecules 12 to more effectively exhibit the optical anisotropy.

Especially, when the horizontal alignment films subjected to alignment treatment such as rubbing treatment or light irradiation treatment are used as the orientation auxiliary material L, the liquid crystal molecules 12 can be aligned in one direction when an electric field is applied. With this, it is possible to further more effectively exhibit the optical anisotropy when an electric field is applied. When the optical anisotropy can be effectively exhibited, it is possible to realize a display element capable of driving at a lower voltage.

The horizontal alignment films are provided respectively in the pair of the substrates 13 and 14, and provided in such a manner that rubbing directions in the rubbing treatment or light irradiation directions in the light irradiation treatment are parallel, antiparallel, or orthogonal to each other. With this arrangement, as in the conventional nematic liquid crystal mode, light utilization efficiency upon application of an electric field increases, which thus improves a transmittance. This makes it possible to carry out a low-voltage driving and to reliably fix the orientational direction of the liquid crystal molecules 12 in the vicinities of the surfaces of the horizontal alignment films in the dielectric substance layer 3 to a desired direction. Especially, in this arrangement, the rubbing treatment or the light irradiation treatment is performed in such a manner that the rubbing directions or the light irradiation directions are mutually different. For example, the horizontal alignment films are provided so that the rubbing directions or the light irradiation directions are orthogonal to each other. This allows the liquid crystal molecules 12 making up the liquid crystalline medium to be oriented so as to form twisted structure when an electric field is applied. That is, the liquid crystal molecules 12 can be oriented so as to form the twisted structure in which the major axis direction of the liquid crystal molecules 12 is directed to the direction parallel to the substance surfaces, and the liquid crystal molecules 12 are oriented so as to be twisted in sequence in the direction parallel to the substrate surfaces from one substrate side to the other substrate side. This makes it possible to alleviate the coloring phenomenon due to wavelength dispersion of the liquid crystalline medium.

Further, as described above, the orientation auxiliary material L for promoting exhibition of optical anisotropy by application of an electric field is not necessarily provided on the opposing surfaces of the substrates 13 and 14. It is safe that the orientation auxiliary material L is provided between the pair of the substrates 13 and 14, more specifically, between the pair of the substrates 1 and 2.

As to a dielectric substance exhibiting optical isotropy when no electric field is applied and exhibiting optical anisotropy by application of an electric field, especially, a display element carrying out display operation by using a dielectric substance exhibiting optical anisotropy due to the change in orientational direction of molecules by application of an electric field, it conventionally suffers from a drawback in that it exhibits high-speed response property and wide viewing angle property but also requires a very high driving voltage.

On the contrary, as described previously, the orientation auxiliary material L is provided between the pair of substrates 1 and 2. This makes it possible to promote the change in orientation of the liquid crystal molecules 12 in the dielectric substance by application of an electric field and to exhibit optical anisotropy more efficiently when an electric field is applied. As such, as described previously, provision of the orientation auxiliary material L between the pair of substrates 1 and 2 makes it possible to exhibit optical anisotropy with a low voltage. Thus, it is possible to attain a display element that is operable with a driving voltage of a practical level and that has high-speed response property and wide viewing angle property.

In the present embodiment, the orientation auxiliary material 1 may be provided in the dielectric substance layer 3. In this arrangement, the orientation auxiliary material L preferably has structural anisotropy. Further, the orientation auxiliary material L is preferably formed in such a state that the liquid crystalline medium in the dielectric substance layer 3 exhibits a liquid crystal phase. The orientation auxiliary material L may be made of a polymerized compound or a polymer compound. The orientation auxiliary material L may be made of (i) at least one polymer compound selected from the group consisting of a chain polymer compound, a network polymer compound, and a cyclic polymer compound, (ii) hydrogen bonding material, or (iii) porous material.

The above-mentioned arrangements are preferable for the orientation auxiliary material L for promoting exhibition of optical anisotropy by application of an electric field.

Further, the orientation auxiliary material L is preferably the one (material) which divides the liquid crystalline medium in the dielectric substance layer 3 into small regions. Particularly, the size of the small region is preferably not more than the wavelength of visible light.

According to the above arrangement, the liquid crystalline medium is kept in the small regions, preferably micro regions each of which is not more than the wavelength of visible light, so that the liquid crystalline medium can exhibit the electro-optical effect (e.g. Kerr effect) caused by application of an electric field in a wide temperature range where the isotropic phase exhibits. In a case where the size of the small region is not more than the wavelength of visible light, it is possible to prevent light diffusion caused by mismatching in refractive index between the orientation auxiliary material L, i.e. the material that divides the liquid crystalline medium into small regions, and the liquid crystalline medium. This realizes a high-contrast display element 20.

That is, the dielectric substance layer 3 of the display element 20 according to the present embodiment may include the aforesaid orientation auxiliary material L as well as the medium 11, specifically, the negative type liquid crystalline mixture (liquid crystalline medium). Further, the orientation auxiliary material L may be provided instead of the horizontal alignment films serving as the orientation auxiliary material L, or may be provided together with the horizontal alignment films. Note that, the following description exemplifies the arrangement in which the display element 20 illustrated in FIG. 2 includes the dielectric substance layer 3 having the aforesaid orientation auxiliary material L formed therein. However, the present invention is not limited to this arrangement.

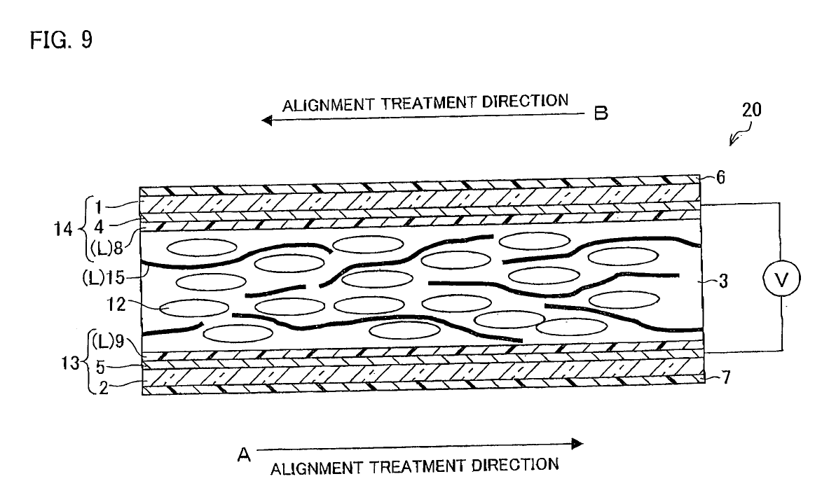

For example, the orientation auxiliary material L formed in the dielectric substance layer 3 can be obtained by the following method: Further, in addition to the negative-type liquid crystal mixture, appropriate amounts of a photopolymerizable monomer (polymerizable compound) and a photopolymerization initiator are added in advance to the negative type liquid crystalline mixture. Then, the resulting liquid crystalline mixture is subjected to ultraviolet (UV) irradiation in the state where the liquid crystalline mixture is in the nematic phase, whereby the photopolymerizable monomer is polymerized. This forms polymer chains 15 in the dielectric substance layer 3, as illustrated in FIG. 9.

In this case, since the UV irradiation is performed with the negative type liquid crystalline mixture exhibiting a nematic phase, the polymer chains 15 are fixed in such a state that even the liquid crystal molecules 12 inside the display element 20 (inside the cell) are uniformly oriented along the alignment treatment directions A and B of the surfaces of the alignment films 8 and 9, as illustrated in FIG. 9.

More specifically, the polymer chain 15 takes the form of a three-dimensional wall with a certain size so as to surround the uniaxially-oriented liquid crystal molecules 12. Here, the size of the region (capsule, small section) surrounded by the polymer chain 15 is determined depending on the amount of the photopolymerizable monomer (polymerizable compound) added, the irradiation energy of UV light, and others. However, to prevent a decrease in contrast due to light diffusion caused by mismatch in refractive index between the polymer compound (chain polymer compound) constituting the polymer chain 15 and the liquid crystal molecule 12 (refractive-index mismatch), the size of the capsule (small section) is preferably not more than the wavelength of visible light.

As described, for example, the dielectric substance layer 3 in the nematic phase undergone the formation (fixing) of the polymer chains 15 therein, is heated at a temperature for exhibiting the isotropic phase, which is above the nematic-isotropic phase transition temperature (Tₙᵢ) and within the temperature range for driving the display element 20 of the present embodiment. Consequently, the liquid crystalline medium in each capsule transits its phase into an optically isotropic phase.

However, a display element having a capsule structure or a network structure using a polymer compound ensures the effect of the wall of the polymer compound (anchoring effect of the polymer wall) even when the liquid crystal molecules 2 are in the isotropic phase, thereby enlarging an available temperature range. As such, according to the present embodiment, it is possible to realize a display element that can be driven in a wider temperature range.

Next, the formation (fixing) of the polymer chain 15 (chain polymer compound) will be described in details below.

The polymer chain 15 is a polymer compound obtained through polymerization (hardening) of a polymerizable compound such as photopolymerizable monomer. For example, the polymer chain 15 is obtained through polymerization of a compound (liquid crystal (meth)acrylate, photopolymerizable monomer) represented by the following Structural Formula (9):

CH₂═CR³COO-M¹Y¹_{q}M²Y²-M⁸ₙY³R⁴ (9)

Note that, in the foregoing Structural Formula (9), R³ represents a hydrogen atom or a methyl group. Further, q and n individually represent an integer of 0 or 1. When q and n represents the integer (the number of repetition) 0, it indicates a single bond.

Further, in the Structural Formula (9), M¹, M², and M³ individually represent a substituent having six-membered-ring structure, such as a 1,4-phenylene group, or a trans-1,4-cyclohexylene group. However, M¹, M², and M³ are not limited to the substituents given above by way of example, as long as M¹, M², and M³ each comprises any one of the substituents represented by the following structures:

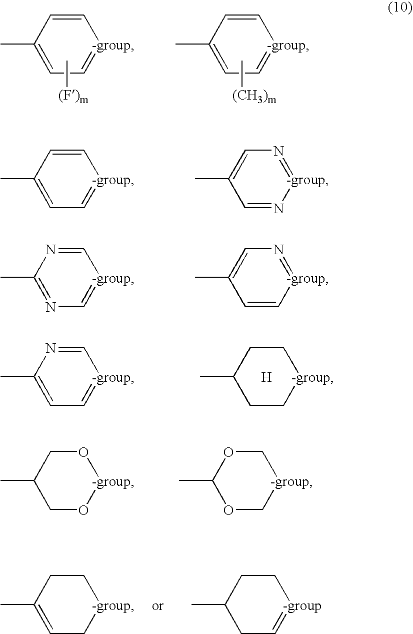

M¹, M², and M³ may be substituents of the same kind, or may be substituents of mutually different kinds. Note that, in the substituents having the above structures, m represents an integer selected from 1 to 4.

Further, in the Structural Formula (9), Y¹ and Y₂ individually represent —CH₂CH₂-group, —CH₂O—, —OCH₂-group, —OCO-group, —COO-group, —CH═CH-group, —C═C-group, —CF═CF-group, —(CH₂)₄-group, —CH₂CH₂CH₂O-group, —OCH₂CH₂CH₂-group, —CH═CHCH₂CH₂O-group, or —CH₂CH₂CH═CH-group. Note that, Y¹ and Y₂ both may be of the same kind or may be of mutually different kinds, as long as each of them comprises any one of the foregoing structures.

Further, in the Structural Formula (9), Y³ represents —O-group, —OCO-group, or —COO-group. Further, R⁴ represents hydrogen atom, halogen atom, cyano group, an alkyl group with 1-20 carbons, an alkenyl group, alkoxyl group.

The compound represented by the Structural Formula (9) (liquid crystal (meth)acrylate, polymerizable compound), which exhibits a liquid crystal phase at a temperature that is near room temperature, has a high capability of giving the orientation regulating force to the polymer chain 15 (i.e. orientation auxiliary material L) obtained through polymerization of the aforesaid compound. The compound represented by the Structural Formula (9) is therefore preferable as a material for the orientation auxiliary material L to be sealed in the dielectric substance layer 3.

The method of initiating polymerization of these polymerizable polymers (polymerizable compounds) is not particularly limited and can be adopted from among various kinds of methods. However, for speed-up of the polymerization, it is preferable that a polymerization initiator is added to the dielectric substance layer 3 in advance before the polymerization is initiated. The polymerization initiator, but not particularly limited, can be a conventionally known polymerization initiator. More specifically, examples of the polymerization initiator include methyl ethyl ketone peroxide.

Now, the following will describe one example (one production example) of the production method of the display element 20 having formed therein the orientation auxiliary material L realized by the polymer chains 15.

In the production method of the display element 20 having formed therein the orientation auxiliary material L realized by the polymer chains 15, the following process is as described previously. That is, the electrodes 4 and 5 and the alignment films 8 and 9 are layered respectively on the substrates 1 and 2 to form the substrates 13 and 14, and then the substrates 13 and 14 are bonded to each other with a sealing agent (not shown) through a spacer (not shown) such as plastic beads or glass fiber spacer, if necessary. Thus, the formation of the orientation auxiliary material L realized by the polymer chains 15 in the dielectric substance layer 3, can be also realized by a similar method to the aforementioned production method. Further, also in the present production example, the substrates (electrode substrates) 13 and 14 are adjusted so as to have 1.3 μm spacing (thickness of the dielectric substance layer 3) between them through a spacer (not shown) such as plastic beads, and then bonded with a sealing agent (not shown) provided around the substrates 13 and 14. In the bonding, a part serving as an inlet (not shown) of the medium 11 (dielectric liquid) to be injected is left open without being sealed. Still further, also in the present production example, after the medium 11 is injected into a spacing between the bonded substrates 13 and 14, the inlet is sealed to complete a cell, and the polarizing plates 6 and 7 are bonded to the cell from outside.

In the present production example, into the medium 11 provided between the substrates 13 and 14, i.e. the negative type liquid crystalline mixture (liquid crystal material (1), liquid crystalline medium), injected is (i) liquid crystal (meth) acrylate (polymerizable compound) which is a kind of photopolymerizable monomer and represented by the Structural Formula (9), as the orientation auxiliary material L (orientation auxiliary material), and (ii) methyl ethyl ketone peroxide, as the polymerization initiator, added to the liquid crystal (meth)acrylate. The amount of the photopolymerizable monomer (polymerizable compound) added is preferably in a range from 0.05 wt % to 15 wt % relative to the medium 11 (liquid crystalline medium). The reason for this is as follows: When the amount of the photopolymerizable monomer (polymerizable compound) added is less than 0.05 wt % relative to the medium 11, a proportion of the polymer chains 15 formed through polymerization (hardening) of the photopolymerizable monomer becomes low relative to the medium 11. This decreases the function of the orientation auxiliary material L, and the orientation regulating force could be exerted insufficiently. On the other hand, when the amount of the photopolymerizable monomer (polymerizable compound) added exceeds 15 wt % relative to the medium 11, the ratio of an electric field applied to the orientation auxiliary material L realized by the polymer chains 15 tends to be large and thus increase a driving voltage.

Further, when the photopolymerizable monomer (polymerizable compound) is added in an amount within the above range relative to the medium 11, the uniaxially-oriented liquid crystal molecules 12 can be surrounded by the polymer chains 15 taking the form of a three-dimensional wall having a size of not more than the wavelength of visible light. As described previously, it is possible to prevent decrease in contrast due to light diffusion caused by mismatch in refractive index between the obtained polymer chain 15 (polymer compound) and the liquid crystal molecule 12.

The amount of the polymerization initiator added relative to the polymerizable compound is set appropriately according to a type, a usage amount, and others of the polymerizable compound, but is not particularly limited. However, the amount of the polymerization initiator added is preferably not more than 10 wt % relative to the polymerizable compound, in order to prevent reduction in specific resistance of the display element 20. If the amount of the polymerization initiator added exceeds 10 wt %, the polymerization initiator could act as an impurity and cause reduction in specific resistance of the display element.

In the present embodiment, the polymerization conditions (reaction conditions) for the polymerizable compound are not particularly limited. However, as described previously, the orientation auxiliary material L is preferably formed in the state where the medium 11 (liquid crystalline medium) exhibits a liquid crystal phase. Thus, the orientation auxiliary material L is formed in the state where the liquid crystalline medium in the dielectric substance layer 3 exhibits a liquid crystal phase, i.e. nematic liquid crystal phase in the present embodiment. This causes a high proportion of the obtained orientation auxiliary material L (polymer chain 15) substantially parallel to the orientational direction of the liquid crystal molecules 12 constituting the liquid crystalline medium, in the state where the liquid crystalline medium exhibits a liquid crystal phase (nematic liquid crystal phase).

Specifically, in the present embodiment, as described previously, in the state where the medium 11 constituting the dielectric substance layer 3 exhibits a liquid crystal phase, the liquid crystal molecules are oriented along the alignment treatment directions A and B, as illustrated in FIG. 2, under the influence of the alignment treatment performed on the alignment films 8 and 9. Thus, the photopolymerizable monomer is polymerized under this condition. As illustrated in FIG. 9, this causes a high proportion of the resulting polymer chains 15, having been obtained through the polymerization, directed along the orientational direction of the liquid crystal molecules 12. That is, the polymer chains 15 have a structural anisotropy so as to have a high proportion of the polymer chains 15 directed in the orientational direction of the liquid crystal molecules 12, which are oriented under the influence of the alignment treatment. According to the present embodiment, the orientation auxiliary material L has structural anisotropy, as described above. With this arrangement, the change in orientational direction of the liquid crystal molecules 12 in the dielectric substance layer 3 can be promoted by intermolecular interactions with the orientation auxiliary material L.

The display element 20 under such a structure is maintained in a liquid phase (isotropic phase) at a temperature near the nematic-isotropic phase transition temperature (Tₙᵢ) (i.e. at a temperature Tₑ which is slightly higher than Tₙᵢ, for example, Tₑ=Tₙᵢ+0.1K), and a voltage is applied between the electrodes 4 and 5. As a result, the liquid crystal molecules 12 begin to orient not only in the vicinities of the surfaces of the alignment films 8 and 9, but also in the whole regions including the bulk region. Further, as the voltage increases, the orientational order of the liquid crystal molecules 12 increases in all regions of the dielectric substance layer 3. Thus, it is possible to obtain greater optical response.

The reason for this is as follows: The display element 20 illustrated in FIG. 9 has the polymer chains 15, which are formed in advance in such a manner so as to be oriented in a desirable direction, all over the inside of the cell. On the contrary, for example, the display element 20 illustrated in FIG. 2 has no orientation auxiliary material L realized by the polymer chains 15, and for example, only the alignment treatments performed on the surfaces of the substrates 13 and 14 (alignment films 8 and 9) play a role in promoting the orientation of the molecules. More specifically, in the display element 20 of the present production example, the polymer chains 15 formed in such a manner that the proportion of the polymer chains 15 oriented along the alignment treatment directions is high, in addition to the alignment treatment performed on the alignment films 8 and 9, plays a roll in promoting the orientation of the liquid crystal molecules 12 in the alignment treatment directions. With this arrangement, it is possible to obtain a maximum transmittance with an even lower voltage.

As described above, according to the present embodiment, upon application of an electric field, the orientation auxiliary material L can promote the liquid crystal molecules 12 constituting the liquid crystalline medium to be oriented in a similar direction to the orientational direction of the liquid crystal molecules 12 in the liquid crystal phase. Accordingly, it is possible to reliably promote the exhibition of an optical anisotropy upon application of an electric field.

Note that, in the present embodiment, reaction conditions in the polymerization reaction of the polymerizable compound, such as reaction pressure and reaction time, are not particularly limited, and may be appropriately set according to the type and amount of the polymerizable compound as used, reaction temperature, and others for completion of the polymerization.

The negative type liquid crystalline mixture (liquid crystal material (1)) used in the present production example exhibits a nematic liquid crystal phase at below 62° C. (Tₙᵢ) and exhibits an isotropic phase at 62° C. (Tₙᵢ) or higher. As such, in the present production example, while the substrates 13 and 14 are kept at a temperature lower than the temperature Tₙᵢ (specifically, 40° C.) by an external heat device (not shown), the cell (display element 20) having the medium 11 and the orientation auxiliary material injected between the substrates 13 and 14 was subjected to ultraviolet irradiation. In such a manner, the photopolymerizable monomer injected between the substrates 13 and 14 was polymerized (hardened) in the state where the medium 11 constituting the dielectric substance layer 3 exhibits a liquid crystal phase (nematic liquid crystal phase), so that the polymer chains 15 (orientation auxiliary material L) were formed.

As with the display element 20 illustrated in FIG. 2, while the thus obtained display element 20 (see FIG. 9) is kept at a temperature near above a nematic-isotropic phase transition temperature (Tₙᵢ) (i.e. at a temperature Tₑ which is slightly higher than Tₙᵢ, for example, Tₑ=Tₙᵢ+0.1K) by an external heat device, a voltage is applied between the electrodes 4 and 5. This changes a transmittance. More specifically, while the medium 11 sealed in the dielectric substance layer 3 is in an isotropic phase by being kept at a temperature slightly higher than the nematic-isotropic phase transition temperature (Tₙᵢ) of the medium 11, a voltage is applied between the electrodes 4 and 5. This makes it possible to change a transmittance of the dielectric substance layer 3.

Note that, the medium 11 sealed in the dielectric substance layer 3 may be a single compound that exhibits the liquid crystallinity, or a mixture of plural substances that exhibits the liquid crystallinity. Alternatively, the single compound or the mixture may have a non-liquid crystalline substance mixed therein.

The proportion of the substance (medium) exhibiting liquid crystallinity in the medium 11 sealed in the dielectric substance layer 3, i.e. the liquid crystalline medium (liquid crystalline compound and its mixture, or liquid crystalline mixture of plural substances that exhibits the liquid crystallinity) is preferably not less than 20 wt %, more preferably not less than 50 wt %.

Further, the photopolymerizable monomer (polymerizable compound) is not limited to the above-exemplified compound. For example, the photopolymerizable monomer may be other polymerizable monomer having a liquid crystal structure and a polymerizable functional group in one molecule, i.e. other liquid crystal (meth)acrylate, for example. Note that, to attain halftone display and low-voltage driving at the same time, the liquid crystalline (meth)acrylate is preferably a monofunctional liquid crystalline (meth)acrylate, more preferably monofunctional liquid crystalline acrylate both of which, as represented by the Structural Formula (9), has no flexible linking groups (spacer), such as alkylene group including methylene group (methylene spacer), or oxyalkylene group, etc., between the liquid crystal structure and the polymerizable functional group. More specifically, the photopolymerizable monomer is preferably, for example, (i) a hydroxy-group containing compound having, as a structural unit, a liquid crystal structure with 2 or 3 six-membered rings, such as cyclic alcohols, phenols, aromatic hydroxy compounds, and (ii) (meth)acrylic acid ester, i.e. a monofunctional (meth)acrylate having the liquid crystal structure as much as esters have.

In such a monofunctional (meth)acrylate, there is no flexible linking groups, such as an alkylene group or an oxyalkylene group, between (meth)acryloyl oxy group and the liquid crystal structure. As such, a polymer (polymer compound) obtained through polymerization of the monofunctional (meth)acrylate of this kind, has such a structure that inflexible liquid crystal structure is directly linked to a major chain without linking groups. In this structure, thermal motion of the liquid crystal structure is restricted by the major chain of the polymer compound. Thus, it is possible to more stably orient the liquid crystal molecules 12 which are influenced by the major chain of the polymer.

Further, examples of other polymerizable monomer (photopolymerizable monomer) added to the medium 11 sealed in the dielectric substance layer 3 include epoxy acrylates. Examples of the epoxy acrylates include bisphenol A epoxy acrylate, brominated bisphenol A epoxy acrylate, or phenol novolak epoxy acrylate. The epoxy acrylates have, in one molecule, a combination of (i) an acryl group polymerizable through light irradiation and (ii) a carbonyl group and a hydroxyl group both polymerizable through heating. On this account, a combination of light irradiation and heating can be used for hardening of the epoxyacrylates. In this case, there is a high possibility that at least one of the functional group polymerizable through light irradiation and the functional group polymerizable through heating occurs reaction for polymerization (hardening). This allows for less unreacted portions and sufficient polymerization.

Note that, in this case, a combined use of light irradiation and heating is not always necessary. Alternatively, either one of light irradiation and heating may be used. That is, in the present embodiment, the method for forming the orientation auxiliary material L, i.e. the method of polymerizing the polymerizable monomer is not limited to the method of using the photopolymerizable monomer polymerizable through light irradiation and polymerizing it through ultraviolet (light). The method may be selected appropriately according to characteristics of a polymerizable compound as used. In other words, in the present embodiment, the polymerizable compound (polymerizable monomer) to be added to the medium 11 for formation of to the orientation auxiliary material L is not limited to a photopolymerizable monomer polymerizable through light irradiation, but may be polymerizable monomers polymerizable by other methods than light irradiation.

Further, in addition to the foregoing examples, the polymerizable monomer to be added to the medium 11 sealed in the dielectric substance layer 3 may be, for example, a mixture of an acrylate monomer (e.g. ethyl hexyl acrylate (EHA) or trimethyl hexyl acrylate (TMHA) produced by Aldrich Co. Ltd) and a diacrylate monomer (e.g. “RM257” (product name) produced by Merck Co. Ltd).

In a case where any of the foregoing polymerizable compounds is used, for the reason described previously, the amount of polymerizable compound added is preferable in a range from 0.05 wt % to 15 wt % relative to the medium 11 (liquid crystalline medium), and the amount of polymerization initiator added is preferably not more than 10 wt % relative to the polymerizable compound.

In the present embodiment, in the case where the orientation auxiliary material L is formed with a polymerizable compound, the polymerization initiator is not always necessary to polymerize the polymerizable compound. However, as described previously, for polymerization of the polymerizable compound by means of light or heat into a polymer, it is preferable that the polymerization initiator is added. The addition of the polymerization initiator speeds up the polymerization.

Moreover, in the present production example, the polymerization initiator is methylethylketone peroxide. However, the polymerization initiator is not limited to this exemplary compound. Apart from the exemplary compound, the polymerization initiator may be, for example, benzoyl peroxide, cumene hydroid peroxide, tertially butyl per oxtoate, dicumyl peroxide, benzoyl alkyl ethers polymerization initiator, an acetophenones polymerization initiator, benzophenones polymerization intiator, xanthones polymerization initiator, benzoinethers polymerization initiator, benzylketals polymerization initiator, and the like.

Moreover, among commercially available products, for example, “Darocure 1173, Darocure 1116” made by Merck Co. Ltd., “Irugacure 184, 369, 651, 907” made by Chibachemical, “Cayacure DETX, EPA, and ITA” made by NIPPON KAYAKU Co. Ltd, “DMPAP” made by Aldorich (all product names exemplified here are registered as trademarks) may be used solely, or may be used in combination, if necessary.

The present embodiment has described the case where the polymer chains 15 (chain polymer) is mainly formed as the orientation auxiliary material L by way of taking an example. However, the present invention is not limited to this, as far as the orientation auxiliary material L can help (promote) the orientation of the molecules (liquid crystal molecules 12) by application of an electric field.

As described previously, the orientation auxiliary material L may be, for example, a network polymer compound (network polymer material), a cyclic polymer compound (cyclic polymer material), or the like. The network polymer compound can be easily obtained, for example, by adding a cross-linking agent at or after the polymerization of the polymerizable compound, or by causing crosslinking reaction of a self-crosslinking polymerizable compound, for example, and introducing a three-dimensional network structure into the resulting polymer compound. Similarly, the cyclic polymer compound can be also easily obtained by performing cyclopolymerization or the like by using a polymerizable compound and an addition agent for use selected appropriately. Note that, the polymerization conditions in these polymerization reactions may be appropriately set and are not particularly limited.

In the present embodiment, as described previously, the type of the polymer compound is not limited as far as it can help (promote) the orientation of molecules (liquid crystal molecules 12) by application of an electric field. However, in order to help (promote) the orientation of the molecules (liquid crystal molecules 12), the polymer compound preferably has the degree of polymerization of not less than 8 and not more than 5000. More preferably, it has the degree of polymerization of not less than 10 and not more than 1000.

The degree of polymerization (x) is defined as a value obtained by dividing molecular weight of a polymer compound by weight of its monomer (monomeric unit), i.e. molar mass of a polymerizable compound as used. In case where a polymer compound having a low degree of polymerization (x) is used, the resulting orientation auxiliary material L exhibits characteristics of a monomer (polymerizable compound) constituting the polymer compound (polymer) rather than characteristics of the polymer compound. Thus, the resulting orientation auxiliary material L has a weak structure (structure of the polymer compound), and has difficulty in bringing the effect of helping (promoting) the orientation of the dielectric substance layer 3. Further, in a case where a polymer compound having the degree of polymerization (x) of x>1000, particularly x>5000 is used, the polymer compounds are more heavily entangled with each other. This tends to make it difficult to achieve a three-dimensional network structure. Further, in such a case, even when the three-dimensional network structure is achieved, the three-dimensional network structure is formed in a small space. As a result, the resulting polymer compound tends to reduce the effect of helping (promoting) the orientation of the molecules (liquid crystal molecules 12) by application of an electric field. As such, the degree of polymerization (x) of the polymer compound is preferably within the above-mentioned range.

The proportion of the polymer compound in the dielectric substance layer 3, i.e. the proportion of the polymer compound in the medium 11 (specifically, the proportion of the polymer compound relative to a total weight of the medium 11 (liquid crystalline medium)) and the polymer compound is preferably in a range from 0.05 wt % to 15 wt %. The reason for this is as follows: When the concentration of the polymer compound in the medium 11, i.e. the concentration of hardened portions in the dielectric substance layer 3 (the proportion of the orientation auxiliary material L) is below 0.05 wt %, the function of acting as orientation auxiliary material L decreases (orientation regulating force is weak). When it exceeds 15 wt %, the ratio of an electric field applied to the orientation auxiliary material L becomes large, which thus increases a driving voltage.

Furthermore, the orientation auxiliary material L is not necessarily made of a polymerizable compound. It may be made of, for example, a porous inorganic material. In this case, instead of the polymerizable compound, a sol-gel material (porous inorganic material), such as barium titanate, is added in advance to the medium 11 (dielectric substance (dielectric liquid)) that is to be sealed in the dielectric substance layer 3. This ensures the same effect as in the case where the orientation auxiliary material L realized by the polymer chain 15 is used.

Especially, in case of using a porous material for the material of the orientation auxiliary material L, the porous material layer is formed in the state where only the surfaces of the substrates 13 and 14 (e.g. alignment films 8 and 9), which sandwiches the dielectric substance layer 3, are subjected to alignment treatment. This allows the porous material layer (orientation auxiliary material L) to grow its anisotropy in a self-organizing manner according to anisotropy of the surfaces of the substrates 13 and 14. Thus, in the case of using the porous material, the orientation auxiliary material L is not necessarily formed in the state where the liquid crystalline medium exhibits a liquid crystal phase. This realizes a simplified manufacture process.

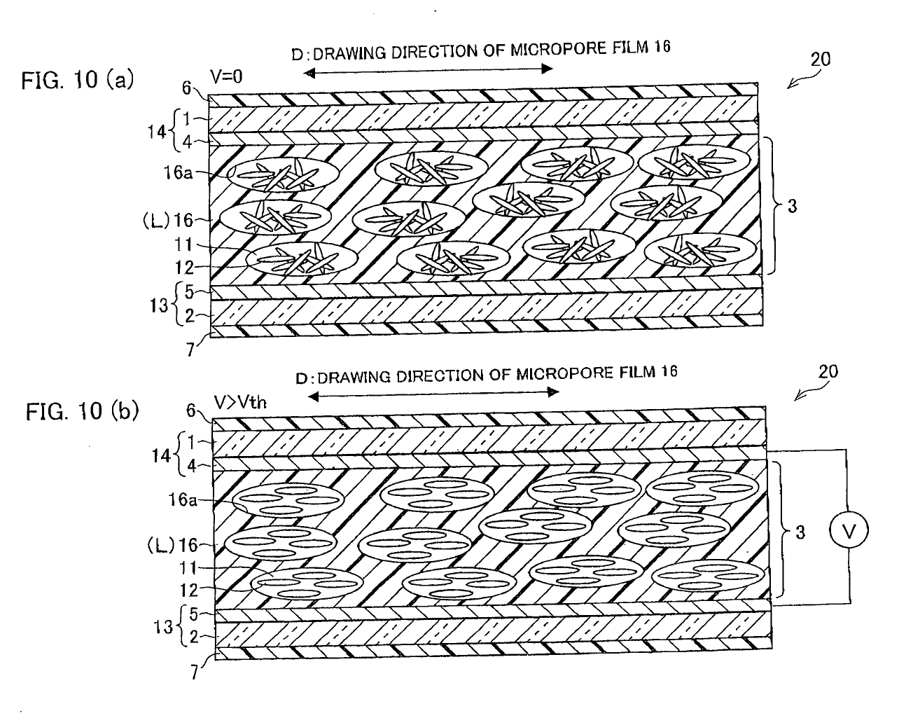

In the present embodiment, apart from the sol-gel material, a micropore film 16, for example, can be used as the porous material. As illustrated in FIGS. 10(a) and 10(b), the micropore film 16 has therein micropores 16a elongated (drawn) in the substrate in-plane direction. FIGS. 10(a) and 10(b) are cross-sectional diagrams schematically illustrating still another structure of the display element 20 according to the present embodiment. FIG. 10(a) is a cross-sectional diagram schematically illustrating orientation of the liquid crystal molecules 12 in the display element 20 when no electric field (voltage) is applied (V=0). FIG. 10(b) is a cross-sectional diagram schematically illustrating orientation of the liquid crystal molecules 12 in the display element illustrated in FIG. 10(a) when an electric field (voltage) is applied (V>Vth (threshold)).

Now, the following describes one example (one production example) of the display element 20 including, as the orientation auxiliary material L realized by the micropore film 16 having therein the micropore 16a elongated (drawn) in one direction of the substrate in-plane directions, the orientation auxiliary material L realized by the micropore film 16 that is a film into which a commercially available film, such as membrane filter, having micropores is drawn.

In the production method of the display element 20 having formed therein the orientation auxiliary material L realized by the micropore film 16, the following process is as described previously. That is, the electrodes 4 and 5 are deposited respectively on the substrates 1 and 2 to form the substrates 13 and 14. However, in a case where the micropore film 16 is formed as the orientation auxiliary material L, alignment films are not necessary on the surfaces of the substrates 13 and 14. In the present production example, as illustrated in FIGS. 10(a) and 10(b), no alignment films are formed on the surfaces of the substrates 13 and 14. Further, also in the present production example, the substrates 13 and 14 are bonded to each other, and then the medium 11 is injected into a spacing between the substrates 13 and 14. Thereafter, the inlet is sealed to complete a cell, and the polarizing plates 6 and 7 are bonded to the cell from outside.

However, in order to form the micropore film 16 as the orientation auxiliary material L, the substrates 13 and 14 are fixed by being sealed with a sealing agent (not shown) around them, except for a part corresponding to the inlet (not shown) of the medium 11 (dielectric liquid) to be injected later, in such a manner that the substrates 13 and 14 sandwich the micropore film 16 having the micropore 16a (communication hole) extended in one direction of the substrate in-plane directions. Thereafter, the medium 11 is injected between the substrates 13 and 14. This makes it possible to form the dielectric substance layer 3 having the micropore film 16 in which the medium 11 is sealed in the micropores 16a. In FIGS. 10(a) and 10(b), the drawing direction of the micropore film 16 is indicated by an arrow D.

As illustrated in FIGS. 10(a) and 10(b), the micropore 16a, which has been drawn in one direction of the substrate in-plane directions as indicated by the arrow D, has a shape of an ellipsoid extended in one direction D of the substrate in-plane directions. As illustrated in FIG. 10(a), in an isotropic phase, the liquid crystal molecules 12 of the medium 11 injected into the micropore 16a are oriented in random directions and optically isotropic. However, in such a state of the liquid crystal molecules 12, when a voltage (V) exceeding a given threshold (Vth) is applied in a normal direction to the substrate, as illustrated in FIG. 10(b), the liquid crystal molecules 12 are oriented on the whole in the same direction as the drawing direction D and exhibit optical anisotropy by turning to the substrate in-plane directions and by being influenced by the elliptically-shaped micropore 16a, more specifically, by being influenced by a wall forming the elliptically-shaped micropore 16a (outer wall of micropore).

Considering light utilization efficiency, the absorption axes 6a and 7a of the polarizing plates 6 and 7 preferably form an angle of 45° with the drawing direction D of the micropore film 16.

For example, as described previously, a film into which a commercial film having micropores, such as a membrane filter, is drawn may be used as the micropore film 16. Specific examples of the membrane filter include “Nuclepore” (product name; produced by Nomura Micro Science Co., Ltd.), “Isopore” (product name; Japan Milipore Co. Ltd), “Hipore” (product name; Asahi Kasei), “Millipore” (product name; Japan Millipore), and “U-pore” (product name; Ube Industries. Ltd.).

Note that, the membrane filter is preferably made of, for example, a polycarbonate, polyolefin, cellulose mixed ester, cellulose acetate, polyvinylidene fluoride, acetyl cellulose, or a mixture of acetyl cellulose and cellulose nitrate, which does not react with the dielectric substance such as a liquid crystalline material) sealed in the micropore film 16.

The size (i.e. diameter) of the micropore 16a in the drawing direction (ellipsoid's major axis direction) of the micropore film 16 is preferably not more than ¼ of the wavelength of visible light, more specifically not more than 140 nm, in order that the dielectric substance layer 3 can be optically isotropic when the medium 11 is sealed in the micropore film 16 (micropore 16a), and also that the medium 11 (liquid crystal molecule 12) can be fixed. This arrangement allows the dielectric substance layer 3 to exhibit sufficient transparency.

Further, the thickness of the micropore film 16 is preferably not more than 50 μm, more preferably not more than 10 μm.

Further, the micropore film 16 may have a twisted structure as in a helical crystal, for example. Examples of the micropore film 16 having such a structure include a polyolefin-type film and polypeptide-type film.

The polypeptide-type film with a twisted structure is preferably a synthetic polypeptide having a helical structure, i.e. α-helix formation ability.

Examples of the synthetic polypeptide having α-helix formation ability include: polyglutamic acid derivative such as poly-γ-benzyl-L-glutamate, poly-γ-methyl-L-glutamate, and poly-γ-ethyl-L-glutamate; polyaspartic acid derivative such as poly-β-benzyl-L-aspartate; poly-L-leucine; and poly-L-alanine.

These synthetic polypeptides can be commercially available synthetic polypeptides or synthetic polypeptides produced according to a method described in a document or the like, both of which can be used as they are or by being diluted by water-insoluble helix solvent such as 1,2-dichloroethane or dichloromethane.

Examples of the commercially available synthetic polypeptide having α-helix formation ability include, poly-γ-methyl-L-glutamate, such as “Ajicoat A-2000” (product name; produced by Ajinomoto Co. Ltd), or “XB-900” (product name; produced by Ajinomoto Co. Ltd), and “PLG-10, -20, -30” (product name; Kyowa Hakko Co. Ltd).

By using the micropore film 16 having a twisted structure as described above as the orientation auxiliary material L, it is possible to prevent great distortion when the medium (dielectric substance) 11 in a chiral state and the micropore film 16 are similar in their twisted structure. This improves stability of the medium 11. Further, by using the micropore film 16 having a twisted structure as described above as the orientation auxiliary material L, the medium 11, even in an achiral state, is oriented in accordance with the twisted structure of the micropore film 16. As a result, the medium 11 exhibits characteristics similar to those of the medium 11 in a chiral state.

Furthermore, another porous material for the orientation auxiliary material L may be a porous inorganic layer composed of fine particles, for example, a porous inorganic material composed of polystyrene fine particles and SiO₂ fine particles.

Now, the following will describe one example (one production example) of the production method of the display element 20 having formed therein the orientation auxiliary material L realized by the porous inorganic layer. In the production example given below, assume that the display element 20 produced in the present production example has the orientation auxiliary material L realized by the porous inorganic layer, instead of the alignment films 8 and 9 and the micropore film 16 as the orientation auxiliary material L in the previously-described display element 20 having the micropore film 16 provided therein.

The following describes how to form the porous inorganic layer composed of polystyrene fine particles and SiO₂ fine particles. First of all, for example, the substrates 1 and 2 (glass substrates) with the electrodes 4 and 5 respectively formed thereon, as substrates with transparent electrodes, are dipped in, for example, an aqueous solution in which the polystyrene fine particles having weight average fine particle diameter of 100 nm and the SiO₂ fine particles having weight average fine particle diameter of 5 nm are mixed and dispersed, and then a mixed fine particles layer having thickness of several μm is formed by a crystal pulling method using self-assembly characteristics of the mixed fine particles, followed by high-temperature sintering to gasify the polystyrene. As a result, instead of the orientation auxiliary material L realized by the alignment films 8 and 9 illustrated in FIGS. 2, 9 or other drawing, a porous inorganic layer of an inverse-opal structure with 100 nm-diameter micropores as the orientation auxiliary material L is formed on the substrates 1 and 2 having the electrodes 4 and 5 respectively formed thereon (electrode substrates). This realizes the substrates 13 and 14 with the orientation auxiliary material. Thereafter, the substrates 13 and 14 are fixed by being sealed with a sealing agent (not shown) around them except for the part corresponding to an inlet (not shown) of the medium 11 (dielectric liquid) to be injected, and the medium 11 is injected between the substrates 13 and 14. As a result, it is possible to obtain a cell (display element 20) including the dielectric substance layer 3 having the porous inorganic layer in which the medium 11 is sealed in micropores.

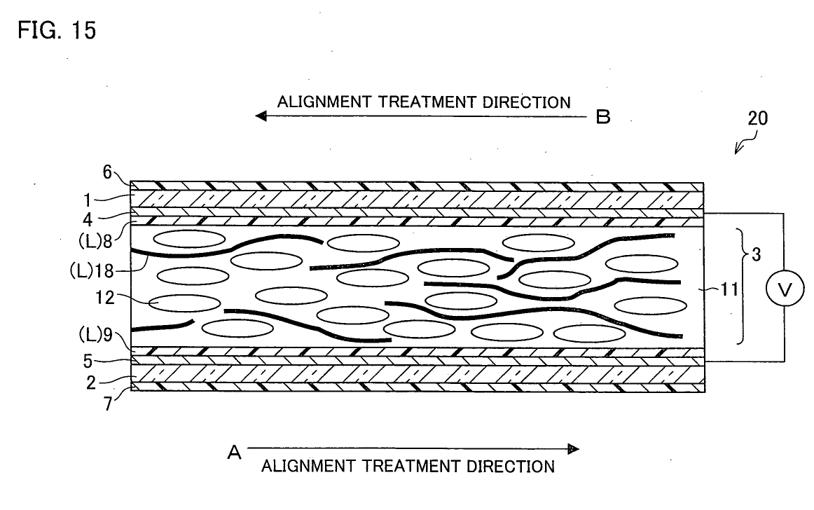

Further, a hydrogen-bonded network 18 (hydrogen-bonded cluster) may be used as the orientation auxiliary material L in the dielectric substance layer 3, as illustrated in FIG. 15. The hydrogen-bonded network here refers to a cluster formed by hydrogen bonding, not chemical bonding, i.e. a cluster having high-electronegativity two atoms, such as oxygen, nitrogen, or fluorine, bonded via a hydrogen atom.

An example of the foregoing hydrogen-bonded network can be a gelatinizer (hydrogen-bonding material; see Non-Patent Document 1, p. 314, FIG. 2) described in “Fast and High-Contrast Electro-optical Switching of Liquid-Crystalline Physical Gels Formation of Oriented Microphase-Separated Structures” by Norihiro Mizoshita, Kenji Hanabusa, and Takashi Kato, Advanced Functional Materials, APRIL 2003, Vol, 13, No. 4, p. 314-317 (hereinafter referred to as “Non-Patent Document 1”), that is obtained by adding and mixing a compound (Lys 18) represented by Structural Formula (10) given below in an amount of 0.15 mol % into the medium 11.

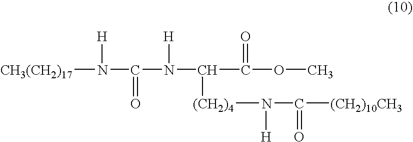

That is, in the present embodiment, the hydrogen-bonded network 18 having a gel structure described in Non-Patent Document 1 (p. 314, FIG. 1), which is realized by mixing the compound (Lys18) represented by the Structural Formula (10) in an amount of 0.15 mol % into the medium 11, can be used as the orientation auxiliary material L. The structure using the above-mentioned hydrogen-bonded network 18 as the orientation auxiliary material L ensures the same effect as in the structure using the orientation auxiliary material L (polymer chain 15) obtained by polymerization of a polymerizable compound.

More specifically, by the addition and mixture of a compound forming the hydrogen-bonded network in the medium 11, e.g. the compound (Lys18) represented by the Structural Formula (10) into the medium 11, the hydrogen-bonded network 18 (hydrogen-bonded cluster) is fixed in such a state that the liquid crystal molecules 12 even inside the display element 20 (inside the cell) are uniformly oriented along the alignment treatment directions A and B of the surfaces of the alignment films 8 and 9, as illustrated in FIG. 15. That is, the hydrogen-bonded network forms a certain-sized, gelled network that surrounds the uniaxially oriented liquid crystal molecule 12, thereby promoting the exhibition of optical anisotropy upon application of an electric field.

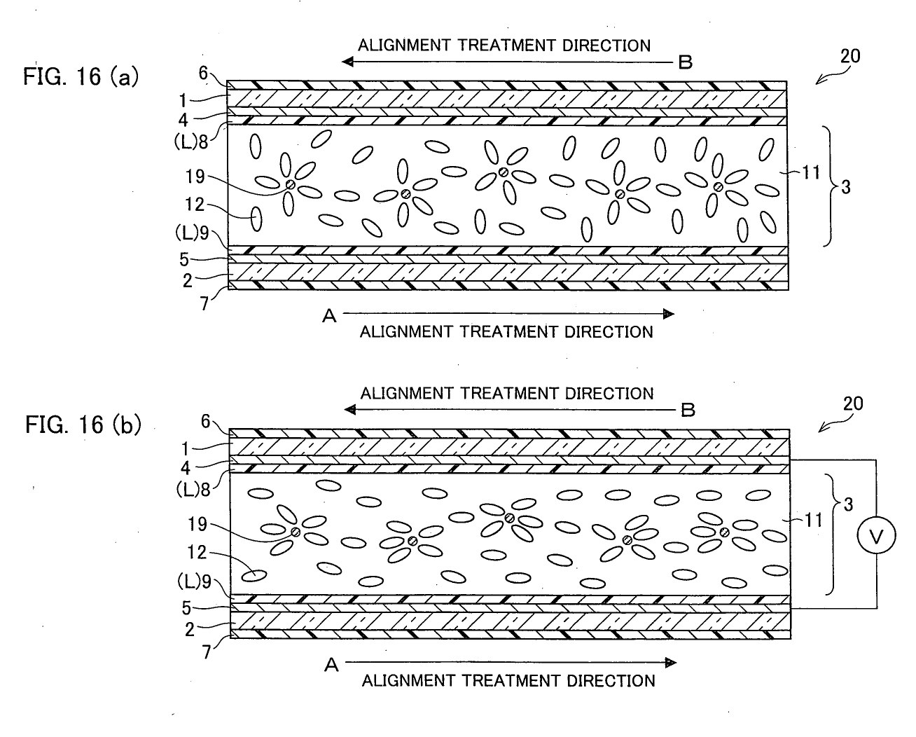

Further, in the present embodiment, the dielectric substance layer 3 may include a particulate 19 by which the orientation auxiliary material L is replaced, or may further include the particulate 19 in addition to the orientation auxiliary material L (e.g. alignment films 8 and 9), as illustrated in FIGS. 16(a) and 16(b).

FIGS. 16(a) and 16(b) are cross-sectional diagrams schematically illustrating yet another structure of the display element 20 according to the present embodiment. FIG. 16(a) is a cross-sectional diagram schematically illustrating orientation of the liquid crystal molecules 12 in the display element 20 when no electric field (voltage) is applied (V=0). FIG. 16(b) is a cross-sectional diagram schematically illustrating orientation of the liquid crystal molecules 12 in the display element illustrated in FIG. 16(a) when an electric field (voltage) is applied (V>Vth (threshold)).

In the present embodiment, as the dielectric substance layer 3, it is possible to realize a system that is filled with agglomerations of the radically orientated liquid crystal molecules 12 and of a size smaller than the wavelength of visible light and that appears optically isotropic. Such system can be a liquid crystal-particle dispersion system (a mixture system in which particulates are dispersed in a solvent (liquid crystal); hereinafter simply referred to as liquid crystal-particle dispersion system) described in, for example, “Palladium nano particle protected with liquid crystal molecules: its Production and Application to a guest-host mode liquid crystal element”, by Yukihide SHIRAISHI and four others, Collected Papers on Macromolecule, December 2002, Vol. 59, No. 12, p 753-759 (hereinafter referred to as “Non-Patent Document 2”). Non-Patent Document 2 discloses, as an example of such a liquid crystal-particle dispersion system, a dispersion liquid of palladium nano particles protected with liquid crystal molecules realized by 4-ciano-4′-pentylbiphenyl (abbreviated as “5CB”), the dispersion liquid being obtained by causing palladium nano particles to absorb 5CB. The application of an electric field to such a liquid crystal-particle dispersion system distorts the radically oriented agglomerations, thereby inducing optical modulation.

Thus, for example, in the system in which the particulates 19 are dispersed in the dielectric substance layer 3, dielectric substance such as the liquid crystal molecule 12 is oriented, influenced by the surface of the particulate 19 (orientation regulating force of the surface of the particulate 19, acting on the dielectric substance layer 3). That is, the medium 11 (dielectric substance) in the vicinity of the surface of the particulate 19 is oriented, significantly influenced by the surface of the particulate 19, and its surrounding medium 11 is oriented so that the entire system having the particulate 19 dispersed becomes in a stable state (i.e. in the state of a low free energy). Accordingly, in the system in which the particulates 19 are dispersed (dielectric substance layer 3), the orientation of the medium 11 (dielectric substance) is stabilized due to dispersion of the particulates 19. Thus, inclusion of the particulates 19 in the dielectric substance layer 3, in other words, addition of the particulates 19 to the medium 11 allows for stable orientation (orientation order) of the medium 11 upon application of no electric field.

That is, in the present embodiment, the aforesaid orientation auxiliary material (orientation auxiliary material L) stabilizes optical anisotropy of the medium 11 by promoting the orientation change of the medium 11 when an electric field is applied. Meanwhile, the particulate 19 functions as an orientation auxiliary material that stabilizes orientation order (i.e. state of optical anisotropy) of the molecules (liquid crystalline molecules 12) in the medium 11 when no electric field is applied by regulating orientation of the molecules (liquid crystalline molecules 12) in the medium 11 when no electric field is applied (hereinafter referred to as “orientation auxiliary material N”).

In this arrangement, the dielectric substance layer 3 is formed by sealing a dielectric material (dielectric substance) such as liquid crystalline substance and the particulates 19. The dielectric substance and the particulates 19 each may be made of a single substance or may be made of two or more substances. As to the dielectric substance layer 3, it is preferable that the particulates 19 are dispersed in the dielectric substance layer 3 in such a manner the particulates 19 are dispersed in the dielectric material (dielectric substance).

In the present embodiment, the particulate (particulate 19) is a particulate whose average particle diameter is not more than 0.2 μm. With the use of the particulates 19 having a micro size to its average particle diameter of not more than 0.2 μm, stable dispersion of the particulates 19 is ensured in the dielectric substance layer 3, thereby preventing aggregation of the particulates 19 or separation of the phase even after a long time. Therefore, it securely prevents unevenness in the display element, caused by partial uneven concentration due to precipitation of the particulates 19.

The particulate 19 is not particularly limited, provided that it has an average particle diameter of not more than 0.2 μm, as described above. However, an average particle diameter of the particulate 19 is preferably not less than 1 nm and not more than 0.2 μm, more preferably not less than 3 nm and not more than 0.1 μm. When a diameter of the particulate 19 is less than 1 nm, the surface of the particulate 19 becomes active. As such, when an average particle diameter of the particulate 19 is less than 1 nm, the particulates 19 are likely to agglomerate. On the other hand, when a particle diameter of the particulate 19 is large, the surface of the particulate 19 becomes less active. Thus, the particulates 19 are less prone to agglomerating as their average particle diameter increases. Further, the use of the particulate 19 whose average particle diameter is not more than 0.2 μm stabilizes dispersion of the particulates 19.

Moreover, it is preferable that particle-particle distance between the particulates be not more than 200 nm, and it is more preferable that particle-particle distance between the particulates be not more than 190 nm. In the present embodiment, in order to regulate the orientation of the medium 11 (dielectric substance), the particulates 19 require spacing where the medium 11 goes into between the particulates. On this account, the particulates 19 are preferably separated from each other (i.e. the particle-particle distance is not 0). More preferably, the particle-particle distance is several nanometers or more (e.g. a molecular length or more of the medium 11 as used). For example, since molecular length of the 5CB is 3 nm, it is preferable that the particle-particle distance is not less than 3 nm.

Generally, when light is radiated on particulates three-dimensionally dispersed, diffraction light occurs at a certain wavelength. The optical isotropy is improved by preventing the occurrence of the diffraction light. As a result, the display element attains better contrast.

A wavelength λ of the diffraction light caused by the particles three-dimensionally dispersed depends on an angle of the light incident on the particles (incident angle), but the wavelength λ is substantially λ=2d, where d is the particle-particle distance between the particulates.

Usually, the diffraction light having a wavelength λ of not more than 400 nm is almost unperceived by human eyes. Thus, in the present embodiment, the wavelength λ of the diffraction light occurs by the particulates 19 used as the orientation auxiliary material N is preferably λ≦400 nm. The particle-particle distance d of not more than 200 nm allows to attain λ≦400 nm.

Further, according to the CIE (Commission Internationale de l' Eclairage), it is determined that the wavelength unperceived by human eyes is 380 nm or less. Therefore, it is further preferable that λ≦380 nm. The particle-particle distance d of not more than 190 nm allows to attain that λ≦380 nm.

As described previously, the particulates 19 sealed in the dielectric substance layer 3 are not particularly limited, provided that they have average particle diameter of not more than 0.2 μm, and may be transparent or may not be transparent. Moreover, the particulates 19 may be organic particulates such as particulates composed of polymer compound, or may be inorganic particulates, metallic particulates, or the like.

In the case where the organic particulates are used as the particulates 19, the organic particulates are preferably particulates in the form of polymer beads. Examples of the particulates in the form of polymer beads include: polystyrene beads, polymethylmethacrylate beads, polyhydroxyacrylate beads, and divinylbenzene beads. Moreover, the organic particulates may be cross-linked or may not be cross-linked.

In the case where the inorganic particulates are used as the particulates 19, the inorganic particulates are preferably, for example, particulates such as glass beads or silica beads.

In the case where the metallic particulates are used as the particulates 19, the metallic particulates are preferably particulates composed of at least one metal selected from the group consisting of alkali metal, alkali earth metal, transition metal, and rare earth metal. For example, the metallic particulates are preferably particulates made of titania, alumina, palladium, silver, gold, copper, or an oxide of these metals. These metallic particulates may be made of sole metal or may be made of an alloy of two or more metals or a complex of two or more metals. For example, the metallic particulates may be particulates prepared by covering silver particulates with titania and/or palladium. The metallic particulates realized by only silver particulates could possibly change properties of the display element due to oxidation of silver. By covering the surfaces of the silver particulates with a metal such as palladium, it is possible to prevent the oxidation of silver. Moreover, as the particulates 19, the metallic particulates in the form of beads may be used as they are, or may be used after subjected to heat treatment or application an organic material on the surfaces of the beads (i.e. the surfaces of the metallic particulates in the form of beads). In such a case, the organic material to be applied on the surfaces of the beads is preferably a material exhibiting liquid crystallinity. By applying an organic material exhibiting liquid crystallinity on the beads surface, the periphery of the medium 11 (dielectric substance) are more easily oriented along liquid crystalline molecules. That is, the orientation regulating force increases

Moreover, it is preferable that the organic material to be applied on the surfaces of the metallic particulates (e.g. surfaces of the metallic particulates) be not less than 1 mole but not more than 50 moles with respect to 1 mole of the metal.

For example, the metallic particulates to which the organic material is applied may be prepared by mixing the organic material into a solvent in which metal ions are solved or dispersed, and then reducing the metal ions. The solvent may be water, alcohols, ethers, or the like.

Further, the particulates 19 to be dispersed in the dielectric substance layer may be in the form of fullerene, and/or in a carbon nanotube. The fullerene should be such that carbon atoms are arranged in a spherical shell configuration therein. For example, a preferable fullerene is such that has a stable structure having 24 to 96 carbon atoms. Examples of such fullerene include a spherical closed-shell carbon molecular structure of C60 comprising 60 carbon atoms. Moreover, the carbon nanotube, for example, may be a single-layer carbon nanotube, or a multiplayer carbon nanotube (e.g. a layer having two to several tens of atoms. Further, the carbon nanotube may be a conical carbon nanocone (nanohorn). The carbon nanotube is preferably a cylindrical nanotube made by rolling up a graphitoid carbon atom plane having 1 to 10 atomic layers.

Moreover, the shape of the particulates 19 is not particularly limited. For example, the shape may be a spherical shape, ellipsoidal shape, agglomeration-like shape, column-like shape, cone-like shape, any of these shapes (forms) with protrusion, or any of these shapes (forms) with a hole. Moreover, the particulates 19 are not particularly limited in terms of their surface state. For example, the particulates 19 may have a flat surface or a non-flat surface, or may have a hole or a groove.

In the present embodiment, the concentration (particulate content) of the particulates 19 in the dielectric substance layer 3 are preferably in a range of 0.05 wt % to 20 wt % relative to the sum of the weight of the particulate 19 and the dielectric substance (medium 11) sealed in the dielectric substance layer 3. Adjustment of the concentration of the particulates 19 in the dielectric substance layer 3 in the range of 0.0 wt % to 20 wt % can suppress the agglomeration of the particulates 19. If the concentration of the particulates 19 in the dielectric substance layer 3 (particulate content) is less than 0.05 wt %, the mixture ratio of the particulates 19 to the dielectric substance (medium 11) is so small that the particulates 19 could not exert sufficient operational effects as the orientation auxiliary material N. If the concentration of the particulates 19 in the dielectric substance layer 3 (particulate content) exceeds 20 wt %, the mixture ratio of the particulates 19 is too large to prevent the particulates from agglomeration. The agglomeration of the particulates could cause not only a weak orientation regulating force but also light scattering.

The present embodiment takes as an example the arrangement where the orientation auxiliary material L promotes the expression of optical anisotropy in the display element 20 when an electric field is applied so that the display element 20 provides displays. The present invention is not limited to this arrangement. For example, the dielectric substance layer 3 may include, for displays, a system in which a large amount of chiral agent is added to the liquid crystalline medium exhibiting a nematic liquid crystal phase, especially, a liquid crystalline medium exhibiting cholesteric blue phase (blue phase (BP phase)) that can exhibit in such a system.

The nematic liquid crystal phase is a highly symmetric liquid, crystal phase obtained by adding an order only in the major axis direction to the rod-shaped liquid crystal molecule 12 having a barycenter arranged at random. The cholesteric blue phase has a helical structure obtained by introducing chirality into the liquid crystal molecules 12 exhibiting the nematic liquid crystal phase as a starting phase, and a structure in which a periodical structure along the helical axes as a higher-order structure is superimposed on the nematic phase. Microscopically (locally), the cholesteric blue phase has basically the same structure as the nematic phase. Macroscopically, the cholesteric blue phase has a structure in which helical axes form three-dimensional periodical structure (for example, see “Polymer-stabilized liquid crystal blue phases” by Hirotsugu Kikuchi and four others, p 64-68, [online], Sep. 2, 2002, Nature Materials, vol. 1, (searched on Jul. 10, 2003; the Internet <URL: http://www.nature.com/naturematerals>) ([Non-Patent document 3]), and “Blue phases induced by doping chiral nematic liquid crystals with nonchiral molecules” by Michi Nakata and three others, PHYSICAL REVIEW E, The American Physical Society, 29 Oct. 2003, Vol. 68, No. 4, p. 04710-1 to 04701-6 ([Non-Patent document 4])).

The cholesteric blue phase is a phase that occurs, by temperature increase, in a temperature range higher than a temperature range in which the chiral nematic phase occurs. The cholesteric blue phase is optically isotropic when no electric field is applied thereon, but is optically anisotropic when the electric field is applied.

Incidentally, it is known that, when no electric field is applied, the cholesteric blue phase is not a perfect isotropic phase, but has a three-dimensional periodical structure having a size approximately equal to or smaller than the visible light wavelength.

As described previously, the cholesteric blue phase has a given periodical structure in a certain temperature range, and exists in a relatively stable state with respect to increase in temperature. Thus, display using the liquid crystalline medium exhibiting the cholesteric blue phase, which is stable on its own, eliminates the need for promoting the expression of optical anisotropy by means of the orientation auxiliary material L. This allows for a simplified process.

Specifically, an example of the liquid crystalline medium exhibiting the cholesteric blue phase and being used in the present embodiment is a mixture of “JC1014XX” (product name, nematic liquid crystal mixture produced by Chisso Co. Ltd) of 48.2 mol %, 5CB (4-cyano-4′-pentyl biphenyl (“5CB” (abbreviation of 4-cyano-4′-pentyl biphenyl); produced by Aldrich Co. Ltd.) of 47.4 mmol %, and chiral dopent (“ZLI-4572”; (product name); produced by Merck Co. Ltd) of 4.4 mol %. The mixture containing the above compounds in the above proportions causes expression of the cholesteric blue phase in a temperature range of 1.1K from 331.8K to 330.7K.

Another example of substance (liquid crystalline medium) exhibiting the cholesteric blue phase is a substance (sample) mixed (prepared) and being composed of JC1041XX (nematic liquid crystal mixture; produced by Chisso Co. Ltd) of 50.0 wt %, 5CB (4-cyano-4′-pentyl biphenyl; Nematic liquid crystal; produced by Aldrich Co. Ltd.) of 38.5 wt %, and ZLI-4572 (chiral dopent; produced by Merck Co. Ltd.) of 11.5 wt %. This substance (sample) caused phase transition from liquid isotropy to optical isotropy at 53° C. or lower temperatures. The helical pitch of this substance becomes approximately 220 nm, and color of the substance was not shown.

Further, another sample was prepared with the foregoing mixture sample of 87.1 wt %, TMPTA (trimethylolpropane triacrylate; produced by Aldrich) of 5-4 wt %, RM257 of 7.1 wt %, and DMPA (2,2-dimethoxy-2-phenyl-acetophenone) of 0.4 wt %, and the sample was kept at a temperature near the cholesteric-cholesteric blue phase transition temperature to polymerize the photopolymerizable monomer by ultraviolet irradiation. The sample has a wider temperature range for exhibiting a cholesteric blue phase than the foregoing mixture sample.

Further, the cholesteric blue phase applicable to the present invention has a defective order smaller than the optical wavelength, so that the material is substantially transparent in the optical wavelength region, and shows substantially optically isotropic. Here, “the material is substantially optically isotropic” means the following condition the cholesteric blue phase gives a color reflecting a helical pitch of the liquid crystal and shows the optical isotropy except for the color given due to a helical pitch. Note that, a phenomenon of selectively reflecting light having the wavelength reflecting the helical pitch is called selective reflection. When the wavelength band of the selective reflection is not in the visible range, the cholesteric blue phase, i.e. the liquid crystalline medium (medium 11) does not give a color (the color is not perceived by human eyes). When the wavelength band of the selective reflection is in the visible range, the cholesteric blue phase gives the color corresponding to the wavelength.

Here, when the selective reflection wavelength band or the helical pitch is equal to or greater than 400 nm, the cholesteric blue phase gives a color corresponding to the helical pitch. More specifically, visible light is reflected, and the reflection produces color perceivable by human eyes. Therefore, for example, when the display element of the present invention is applied to TV or the like for realization of full-color display, it is not preferable that reflection peak is in a visible range.

Note that, the selective reflection wavelength also depends on the incident angle to the helical axis of the liquid crystalline medium (medium 11). Therefore, when the structure of the liquid crystalline medium is not one-dimensional, i.e. when the structure of the liquid crystalline medium is three-dimensional as with the cholesteric blue phase, the incident angle to the helical axis of the light has distribution, meaning that the width of the selective reflection wavelength also has distribution.

In view of this, it is preferable that the cholesteric blue phase, i.e. the liquid crystalline medium in the dielectric substance layer 3 has the selective reflection wavelength range or the helical pitch not more than the wavelength of the visible light (not more than the wavelength range of visible light), i.e. not more than 400 nm. If the cholesteric blue phase has the selective reflection wavelength range or the helical pitch not more than 400 nm, the given color explained above is almost unperceivable by human eyes.

Further, according to the CIE (Commission Internationale de l' Eclairage), it is determined that the wavelength unperceivable by human eyes is 380 nm or less. Therefore, it is further preferable that the cholesteric blue phase has the selective reflection wavelength range or the helical pitch of not more than 380 nm. In this case, it is possible to securely prevent such a given color from being perceived by human eyes.

Further, the given color as described above depends on not only the helical pitch and the incident angle but also the average refractive index of the medium. The light of the given color here has the wavelength width of Δλ=PΔn with its center wavelength of λ=nP, where n is average refractive index, P is helical pitch, and Δn is refractive index anisotropy.

Δn differs depending on the material. For example, when a liquid crystalline substance is used as the medium 11, a general liquid crystalline substance has average refractive index n of the order of 1.4 to 1.6 and Δn of the order of 0.1 to 0.3. In this case, in order to make the color given by the medium 11 invisible, the helical pitch P is 400/1.5 nm (=267 nm) when λ=400 and n=1.5. Further, the helical pitch P is 400/1.6 nm (−250 nm) when λ=400 and n=1.6. Still further, the helical pitch P is 0.1×267 nm (=267 mm) when Δn=0.1 and n=1.5. Yet further, the helical pitch P is 0.3×250 nm (=75 nm) when Δn=0.3 and n==1.6. Assume that it is estimated that the average refractive index n and Δλ are high (Δn=0.3 and n=1.6). In this case, when the helical pitch P of the medium 1 is not more than 213 nm resulting from subtracting 37.5 nm, which is about a half of 75 nm, from 250 nm, it is possible to prevent the medium 11 from giving the color mentioned above.

Further, it is further preferable that the helical pitch P of the medium 11 is not more than 200 nm. In the previous descriptions, λ is set to 400 nm (wavelength substantially unperceivable by human eyes) in the formula λ=nP. However, when λ is set to 380 nm (wavelength definitely unperceivable by human eyes according to the CIE (Commission Internationale de l' Eclairage)), the helical pitch P of the medium 11 for preventing such a given color as described above is equal to or less than 240 nm considering the average refractive index n of the medium 11. That is, by setting the helical pitch of the medium 11 to 200 nm or less, it is possible to securely prevent such a given color as described above.

Another example of the substance exhibiting the cholesteric blue phase is a mixture of “ZLI-2293” (product name; mixed liquid crystal produced by Merck Co. Ltd.) of 67.1 wt %, the compound represented by the following Structural Formula (11):

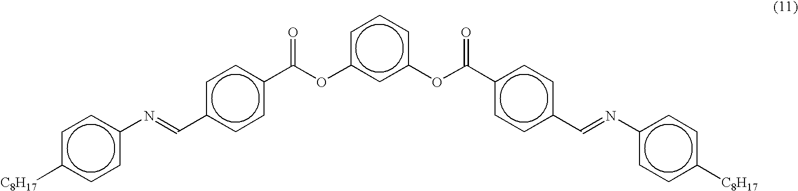

(banana-shaped (curved) liquid crystal; “P8PIMB” (abbreviation) produced by Clariant Corporation) of 15 wt %, and chiral dopant (“MLC-6248” (product name) produced by Merck Co. Ltd.) of 17.9 wt %. The mixture showed the cholesteric blue phase in the temperature range of 77.2° C. to 82.1° C.

Apart from the foregoing mixture, a mixture of “ZLI-2293” (mixed liquid crystal produced by Merck Co. Ltd.) of 67.1%, the compound represented by the following Structural Formula (12):

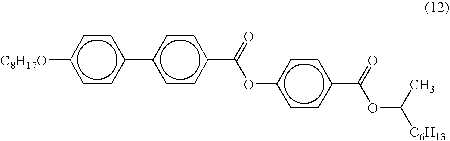

(linear liquid crystal; “MHPOBC” (product name) produced by Clariant Corporation) of 15%, and chiral dopant (“MLC-62487” (product name) produced by Merck Co. Ltd.) of 17.9% showed the cholesteric blue phase in the temperature range of 83.6° C. to 87.9° C.

The mixture of only “ZLI-2293” and “MLC-6248” did not exhibit a cholesteric blue phase. However, by addition of the compound that is a banana-shaped (curved) liquid crystal material (liquid crystalline medium) and represented by the Formula Structure (11) or the compound that is a linear liquid crystal material (liquid crystalline medium) and represented by the Formula Structure (12), the mixture exhibited a cholesteric blue phase.

As the linear liquid crystal material (linear liquid crystal) used in the present embodiment, a lasemic body may be used or a chiral body may be used. As the linear liquid crystal, a compound having a contragradient structure (each layer faces different direction), such as the compound represented by the Structural Formula (11) (specifically, “MHPOBC), is preferable.

The curving portion (connecting portion) in the banana-shaped (curved) liquid crystal material (banana-shaped (curved) liquid crystal) may be a benzene ring such as a phenylene group, otherwise, it may be one coupled by a naphthalene ring, a methylene chain or the like. Further, curving portion (connecting portion) may include an azo group.

Apart from the “P8PIMB”, examples of the banana-shaped (curved) liquid crystal include a compound represented by the following Structural Formula (13):

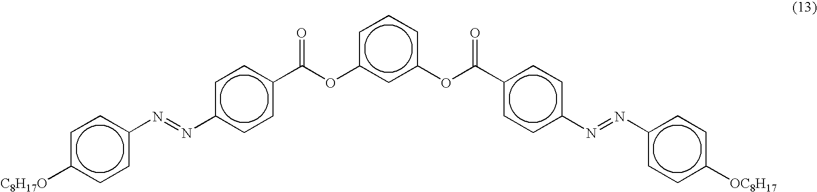

### (“Azo-80” (abbreviation) produced by Clariant Corporation), a compound represented by the following Structural Formula (14):

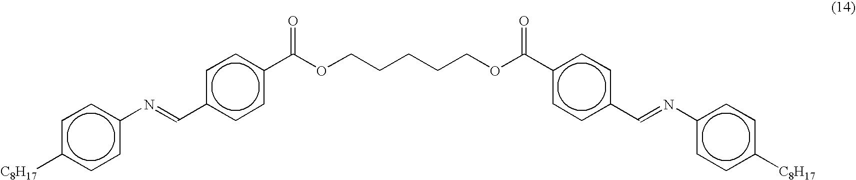

### (“8Am5” (abbreviation) produced by Clariant Corporation), and a compound represented by the following Structural Formula (15):

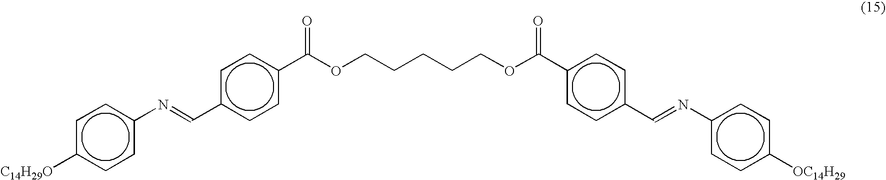

### (“14OAm5” (abbreviation) produced by Clariant Corporation). However, the present invention is not limited to these compounds.

As to the display element in which polymer compound is fixed (stabilized) in the dielectric substance layer 3, like the display element 20 according to the present embodiment, the display element in which the liquid crystal material (liquid crystalline medium) is divided into small regions by the porous material or the like so as to be sealed, or the like material, there can occur drop of an applied voltage (voltage drop) according to the content of the polymer compound and the content of the porous material. That is, in the display element 20 having the foregoing structure, an applied voltage is used for the polymer compound and the porous material, and a driving voltage of the display element 20 increases correspondingly.

However, in the present embodiment, as described previously, refractive index anisotropy Δn and dielectric anisotropy Δ∈ of the liquid crystal material (negative type liquid crystalline mixture) used for the dielectric substance layer 3 are set to be within the aforementioned range, preferably Δn≧0.20 and |Δ∈|≧20, for example. In this case, estimates have already put the driving voltage at 6.8V which is a voltage at which driving is possible by using the conventional TFT element structure and the conventional general-purpose driver. Even if the driving voltage increases almost three times, for example, to 18V due to fixing of the polymer compound and porous material, the driving voltage of 18V can be coped with a 51V-withstand voltage of the gate electrode in the TFT element (gate withstand voltage). 51V is lower by 12V than 63V, which is a limit value of the gate withstand voltage when driving is performed at a first target voltage of 24V. Also, in this case, margins of film thickness and film material of the gate electrode can be increased than ever before. Thus, it is possible to realize an easier-to-manufacture and more practical element structure.

Thus, according to the present embodiment, although the above structure causes increase in cost, to some extent, for the element structure and the driving circuit, it can realize a display element capable of driving in a wide temperature range. Needless to say, this brings advances toward commercial use for the aforesaid display element.

In the present embodiment, for example, as illustrated in FIGS. 2 and 5 and other drawings, mainly described is the arrangement in which the alignment films 8 and 9 are subjected to antiparallel alignment treatment (rubbing) and the alignment treatment directions (rubbing directions) A and B form an angle of 45° with both of the polarizing plates 6 and 7 by way of taking an example. However, the present invention is not limited to this arrangement.

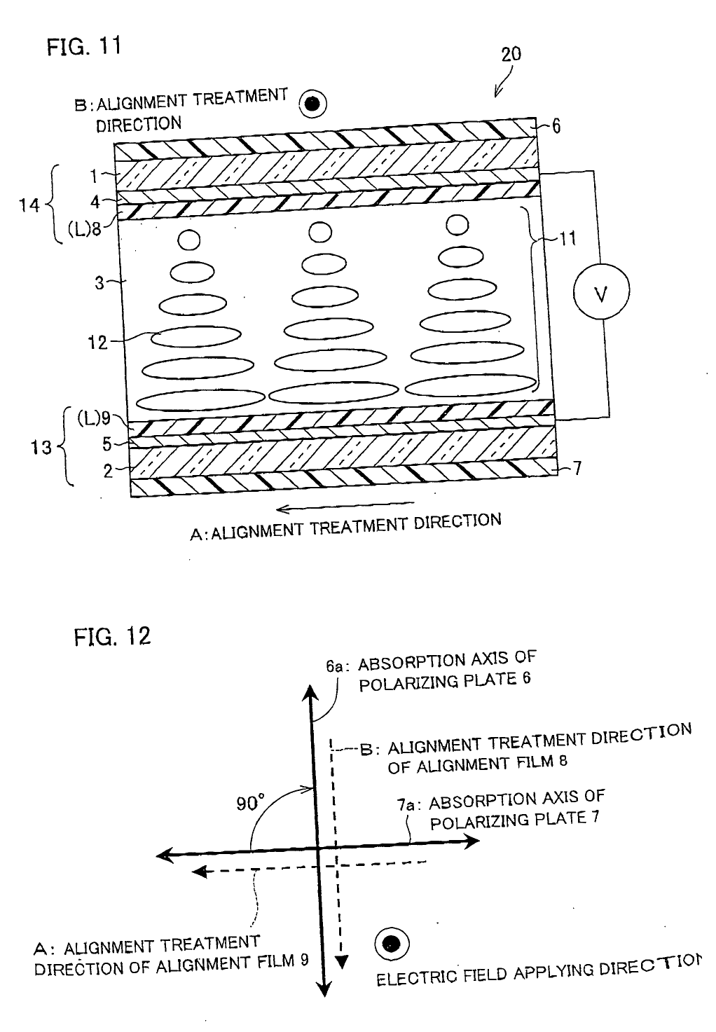

For example, as illustrated in FIGS. 11 and 12, the arrangement as in the conventional TN-LCD may be adopted in which the alignment films 8 and 9 are subjected to alignment treatment (e.g. rubbing treatment) in the mutually orthogonal directions, and with both of the substrates 13 and 14, alignment treatment directions of the surfaces of the substrates 13 and 14 (e.g. rubbing directions of the alignment films 8 and 9) are made parallel or orthogonal to absorption axes directions of the polarizing plates 6 and 7. This arrangement also realizes decrease to a voltage value in the voltage range where driving is possible, considering the withstand voltage of the TFT element. This widely opens a door to the commercial use for the aforementioned display element.

However, the arrangement as illustrated in FIGS. 11 and 12, as described above, so-called TN (Twisted Nematic) type.

The condition for an optimum light utilization efficiency is called 1st minimum condition. The 1st minimum condition is 350 (nm)≦Δn×d≦650 (nm), more preferably 400 (nm) Δn×d≦550 (nm).

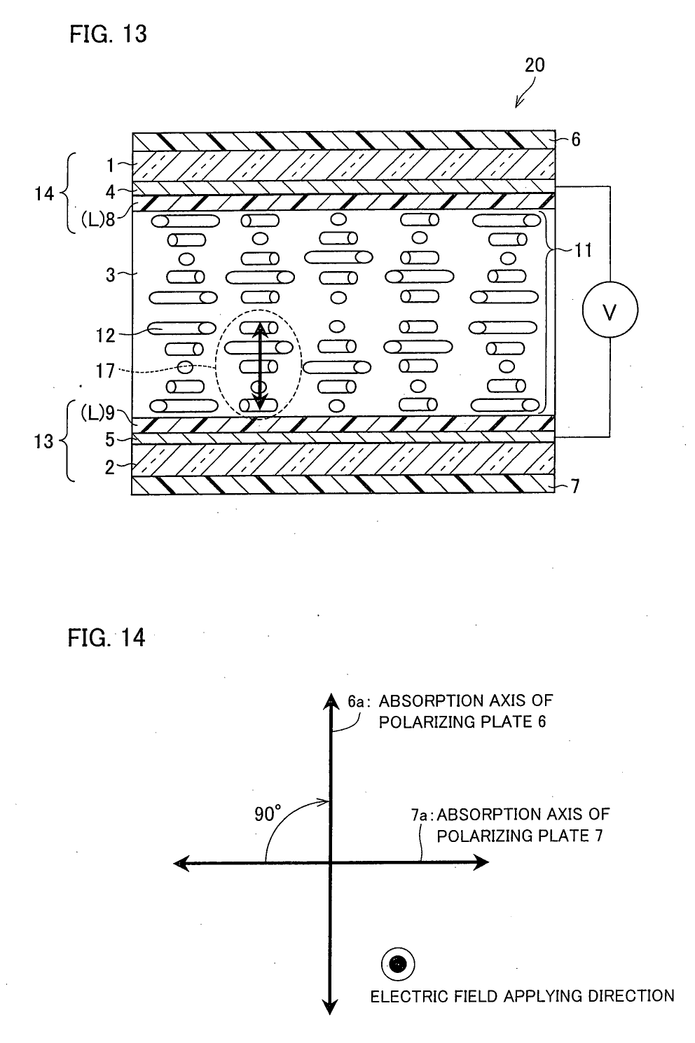

Further, the display element 20 according to the present embodiment may have an arrangement as illustrated in FIGS. 13 and 14 in which the polarizing plates 6 and 7 are provided and the medium 11 constituting the dielectric substance layer 3 has a twisted structure with only one chirality. This arrangement also realizes decrease to a voltage value in the voltage range where driving is possible, considering the withstand voltage of the conventional TFT element. This widely opens a door to the commercial use for the aforementioned display element.

Note that, in the twisted type with only one chirality as illustrated in FIG. 13, it is preferable that the twist pitch is in the visible light wavelength range or in the range less than the visible light wavelength range, considering light utilization efficiency.

Here, the medium 11 (liquid crystalline medium) exhibiting one chirality may be made of, for example, a chiral substance being chiral (optically active) itself. In case where the medium 11 (liquid crystalline medium) is made of the chiral substance, because the medium 11 is optically active. Because of this, the medium 11 itself spontaneously takes the twisted structure and becomes stable. The chiral substance having chirality should be a compound having an asymmetric carbon atom (chiral center) in its molecule.

Specifically, examples of such a chiral substance include 4-(2-methylbutyl)phenyl-4′-octylbiphenyl-4-carboxylate, but the chiral substance is not limited to the above exemplified compound.

Moreover, the medium 11 (liquid crystalline medium) having only one chirality may be, for example, a medium that does not have asymmetric carbon atom (i.e. the molecule itself does not have chirality) but has a molecule that allows the medium to have the chirality as a system by anisotropy and packing structure of the molecule. One of examples of such medium is various kinds of banana-shaped (curved) liquid crystals, as described previously.

Alternatively, the medium 11 may be a chiral-agent-added liquid crystal material including a chiral agent (chiral dopant), which is generally used for liquid crystal, mixed in an appropriate concentration into the liquid crystal material.

In the display element 20 as such, as illustrated in FIG. 13, the application of the electric field between the electrodes 4 and 5 causes the short-distance intermolecular effect, whereby the clusters 17 (agglomerations of the liquid crystal molecules 12) occur, which has one chirality, i.e. a twisted structure with either one of right-handed twist or left-handed twist. This causes optical activity. That is, in the display element 20, the liquid crystal molecules 12 exhibiting optical anisotropy are orientated in the twist structure with only one chirality.

Therefore, the display element 20 has a constant optical activity even if the clusters 17 (each twisted structures) have no directional correlation between themselves. Thus, the display element 20 has a large optical activity as a whole. Because of this, the voltage to attain the maximum transmittance is much lower in the present display element 20 than in the conventional display element.

Particularly, addition of the chiral agent into the medium 11 (liquid crystal material) ensures that the liquid crystal molecules 12 in the medium 11 are orientated in the twisted structure with only one chirality.

That is, the chiral agent causes the adjacent liquid crystal molecules 12 to form the twisted structure. This lowers energy of the intermolecular interaction in the liquid crystalline medium (liquid crystalline substance). Further, the liquid crystalline medium spontaneously forms the twisted structure and stabilizes the twisted structure. Therefore, the medium 11 (dielectric substance) containing a chiral agent does not cause a dramatic structural change at a temperature near the nematic-isotropic phase transition temperature Tni, but exhibits a liquid crystal phase having an optical isotropy (nematic liquid crystal phase), which lowers the phase transition temperature.

Examples of the chiral agent as such include “C15” (product name; produced by Merck Ltd.), “CN” (product name; produced by Merck Ltd.), and “CB15” (product name; produced by Merck Ltd.), in addition to “ZLI-4572” (product name; produced by Merck Ltd.), “MLC-6248” (product Name; produced by Merck Ltd.) all of which have been mentioned previously. However, the present invention is not limited to these chiral agents.

In the case where the medium 11 includes the chiral agent, for example, in the case where the chiral-agent-added liquid crystal material is used as the medium 11, the concentration of the chiral agent in the medium 11 is not particularly limited, provided that it can stabilize the structure of the liquid crystalline medium (liquid crystalline substance) in the medium 11. The concentration of the chiral agent may be arbitrarily set according to the type of the chiral agent to use, arrangement of the display element, designs, and the like. However, it is preferable that the twist amount in the chiral-agent-added liquid crystal material, that is, the twist pitch (chiral pitch) be within the visible light wavelength range or smaller than the visible light wavelength, for realization of low-voltage driving and high transmittance.

If the chiral pitch is within the visible light wavelength range or smaller than the visible light wavelength, the incident light is rotated because of the one-direction twist of the chiral agent resulting from a spontaneous twist direction of the chiral agent, which occurs in the medium 11 by the electric field application. The rotation of the incident light makes it possible to output the light efficiently. As a result, it becomes possible to attain the maximum transmittance with a low voltage. Thus, it becomes possible to realize the display element 20 which can be driven with a low driving voltage and which is excellent in light utilization efficiency. In order to attain the rotation of polarization planes by using an optically active material such as the chiral-agent-added liquid crystal material, it is preferable that the one-direction chiral twist (natural chiral pitch) satisfy the above conditions.

In addition, for this realization, for example, the chiral agent content of the chiral-agent-added liquid crystal material, i.e. the proportion of the chiral agent (concentration of the chiral agent to be added) to the total amount of the liquid crystalline medium (preferably, the negative type liquid crystalline mixture) and the chiral agent is preferably set within the range from 8 wt % to 80 wt %, more preferably, within the range from 30 wt % to 80 wt %.

In the medium 11, by adding the chiral agent of preferably not less than 8 wt % (concentration of chiral agent to be added), in other words, by setting the twist pitch (natural chiral pitch) of the medium to be not more than the visible light wavelength, i.e. within the visible light wavelength region or smaller than the visible light wavelength, the driving temperature range tends to increase. More preferably, in the medium, by adding the chiral agent of not less than 30 wt % (concentration of chiral agent to be added), the reduction in driving voltage and the improvement in light utilization efficiency, in addition to the increase in the driving temperature range, are realized. This makes it possible to more effectively change the degree of optical anisotropy by application of an electric field.

Moreover, when the proportion of the chiral agent to the total amount of the liquid crystalline medium and the chiral agent is not less than 30 wt %, a twist power (helical twist power) of the chiral agent effectively acts on the liquid crystal molecules 12 in the medium 11. This causes short-range intermolecular interaction (short-range-order) between the liquid crystal molecules 12. Therefore, by controlling the proportion of the chiral agent to be added in the liquid crystalline medium in the above-mentioned manner, it is possible to control the chiral pitch so as to be within the visible light wavelength range or smaller than the wavelength of the visible light, as described above. Further, with this arrangement, the liquid crystal molecules 12 of the medium 11 can be caused to respond to the electric field application as agglomerations (clusters) of the liquid crystal molecules 12, the medium 11 being optically isotropic when no electric field is applied. Thus, it is possible to cause the optical anisotropy in a wider temperature range than in the conventional arrangement in which the optical anisotropy can occur in very narrow temperature range.

Note that, in view of the property of the display element 20, the lower limit of the chiral pitch is preferably lower. However, as described above, when the chiral-agent-added liquid crystal material is used as the medium 11 (i.e. when the chiral agent is added to the liquid crystalline substance), addition of excess amount of the chiral agent causes lowering of liquid crystallinity of the dielectric substance layer 3 as a whole. The lack of the liquid crystallinity causes lower occurrence frequency of magnitude of optical anisotropy by application of an electric field. This causes deterioration in the function as the display element. Therefore, in order to allow the display element to function as an element for displaying, the dielectric substance layer 3 should have the liquid crystallinity at least as a whole. According to this, the upper limit of the concentration of the chiral agent to be added is determined. According to the analysis by the present inventors of the present application, it was found that the proportion of the liquid crystalline substance in the dielectric substance layer 3 is preferably not less than 20 wt %, and that a sufficient electro-optical effect could not be obtained when the proportion of the liquid crystalline substance is less than 20 wt %, That is, according to the analysis by the present inventors of the present application, it was found that the upper limit concentration of the chiral agent to be added is 80 wt %.

The upper limit of the concentration (chiral concentration) of the chiral agent (that is, lower limit of the chiral pitch) is applied only in the case where the chiral agent is added to the liquid crystalline medium (liquid crystalline substance), as described above. In case where no additive such as the chiral agent is added and the medium 11 itself is chiral with only one chirality, the above-mentioned lower limit of the chiral pitch is not applied.

In the display element 20 according to the present embodiment, the substance that can be used as the medium 11 may be any substance, for example, a substance that shows the Kerr effect, a substance that shows the Pockels effect, other polar molecules, or mixture of these substances, provided that (i) the substance includes a liquid crystalline medium exhibiting a nematic liquid crystal phase; (ii) the substance is optically isotropic when no electric field is applied and is optically anisotropic when an electric field is applied; and (iii) Δn×|Δ∈| in the nematic phase of the liquid crystalline medium exhibiting the nematic liquid crystal phase satisfies the aforesaid conditions.

Especially, the change in the refractive index proportionately to the square of the electric field applied is advantageous that it realizes a fast responding speed. However not only a very fast responding speed but also unlimited viewing angle is attained in the dielectric substance layer 3 made from the medium 11 whose refractive index changes proportionately to the square of the electric field, that is, the medium 11 (liquid crystalline medium) that shows the Kerr effect. The very fast responding speed is attained because the orientational direction of the liquid crystal molecules 12 is changeable by the electric field application, thus the respective liquid crystal molecules 12 randomly directed are rotated to change their directions, by controlling localization of electrons in each molecule. The unlimited viewing angle is attained because the liquid crystal molecules 12 constituting the medium 11 are randomly directed. Thus, according to this arrangement, it is possible to realize a display element having more excellent high-speed response property and wide viewing angle property. Moreover, in this arrangement, it is possible to attain significantly lower driving voltage. Thus, this arrangement is highly practical.

Moreover, with an arrangement in which the dielectric substance layer 3 includes the medium 11 containing polar molecules, the electric field application causes polarization of the polar molecules. The polarization promotes the orientation of the polar molecules. Thus, it becomes possible to cause the optical anisotropy with a lower voltage. Note that, here, the orientation auxiliary material L formed between the pair of the substrates 13 and 14 further promotes the orientation of the polar molecules. Thus, it is possible to realize optical anisotropy with lower voltage. This makes it possible to realize voltage reduction in driving voltage.

It is therefore desirable that the medium 11 contains the polar molecules. The polar molecules are not particularly limited. However, for example, nitrobenzene or the like is preferably used as the polar molecules. Nitrobenzen is a kind of media showing the Kerr effect.

Note that the medium 11 is not limited to a liquid crystalline substance and is preferably arranged such that it has an orderly structure (orientational order) equal to or smaller than the wavelength of light when an electric field is applied or when no electric field is applied. With such orderly structure smaller than the wavelength of light, the medium 11 is optically isotropic. Thus, by using the medium 11 that has the orderly structure smaller than the wavelength of light when the electric field is applied or when no electric field is applied, it is possible to surely change the display state between when the electric field is applied and when no electric field is applied.

Note that, in the present embodiment, the method of exhibiting a liquid crystal phase in forming the orientation auxiliary material L is the method of causing a nematic phase to be exhibited by decreasing the temperature. However, the method of exhibiting a liquid crystal phase in forming the orientation auxiliary material L is not limited to the described method. For example, the liquid crystal molecules 12 may be compulsively aligned without decreasing the temperature by expressing liquid crystal phase through application of a high voltage not required for general display operation, i.e., a lot greater voltage than the driving voltage of the display element 20. More specifically, exhibition of the liquid crystal phase may be caused by a change (decrease in general) in temperature or application of an external field, such as an electric field. Note that, it is preferable that the external field applied to exhibit the liquid crystal phase differs from the environment on display.

Further, in the present embodiment, the substrates 1 and 2 in the display element 20 are realized by glass substrates. However, the present invention is not limited to this arrangement. Still further, in the present embodiment, the distance (d: cell thickness) between the substrates 13 and 14 in the display element 20 is 1.3 μm. The present invention is not limited to this arrangement, and the distance may be set arbitrarily. The cell thickness (d) is preferably thin, considering low-voltage driving. However, since the cell having a thickness of less than 1 μm is difficult to manufacture, the cell thickness (d) is determined in view of the manufacture process. Yet further, in the present embodiment, the electrodes 4 and 5 are realized by ITO. However, the present is not limited to this arrangement, provided that at least one of the electrodes 4 and 5 is realized by a transparent electrode material.

Further, in the display element 20, the alignment films 8 and 9 are the alignment films realized by polyimide films. However, the present invention is not limited to this arrangement. For example, they may be alignment films made of polyamic acid. Alternatively, they may be alignment films made of material (alignment film material) such as polyvinyl alcohol, silane coupling agent, or polyvinyl cinnamate.

In the case where polyamic acid or polyvinyl alcohol is used as the alignment film material, the alignment film material is applied on the substrates 1 and 2 having the electrodes 4 and 5 respectively formed thereon to form the alignment films 8 and 9, and the alignment films 8 and 9 are then subjected to alignment treatment such as rubbing treatment or light irradiation treatment. Further, in the case where silane coupling agent is used as the alignment film material, the films may be formed like a LB film (Langmuir Blodgett Film) through a crystal pulling method. Further, in the case where polyvinyl cinnamate is used as the alignment film material, polyvinyl cinnamate is applied on the substrates 1 and 2 having the electrodes 4 and 5 respectively formed thereon, followed by UV (ultraviolet) irradiation.

Further, the present embodiment takes the case where the alignment treatment directions A and B of the alignment films 8 and 9 are antiparallel to each other, by way of taking an example of the alignment treatment directions. However, the present invention is not limited to this arrangement. For example, the alignment treatment directions A and B of both of the alignment films 8 and 9 may be parallel and the same directions (parallel direction). Alternatively, the alignment treatment may be performed so that the alignment treatment directions of both of the alignment films 8 and 9 are mutually different directions. Further, alignment treatment may be performed to only one of the alignment films 8 and 9.

As described above, the display element according to the present embodiment is such that: electric field applying means for applying an electric field to a substance layer sandwiched between a pair of substrates opposed to each other, for example, produces an electric field in a substrate surface normal direction to the pair of substrates so that an electric field is applied to between the substrates; the substance layer includes a liquid crystalline medium exhibiting a nematic liquid crystal phase and exhibits optical isotropy when no electric field is applied while exhibiting optical anisotropy when an electric field is applied; and it is Δn×|Δ∈|≧1.9 where Δn is a refractive index anisotropy at 550 nm in a nematic phase of the liquid crystalline medium exhibiting the nematic liquid crystal phase, and |Δ∈| is an absolute value of a dielectric anisotropy at 1 kHz in the nematic phase of the liquid crystalline medium exhibiting the nematic liquid crystal phase. This realizes optical anisotropy caused by electric field application at a low voltage with excellent efficiency when an electric field is applied, and realizes driving in a wide temperature range. Further, the display element which performs display operation by using a medium exhibiting optical isotropy when no electric field is applied while exhibiting anisotropy when an electric field is applied, inherently has a high-speed response property and a wide viewing angle property. Therefore, according to the present embodiment, it is possible to attain a display element which realizes a high response speed, a low driving voltage, and driving in a wide temperature range. Thus, with the above arrangement, the door is opened to the practical use for such a display element inherently having high-speed response property and wide viewing angle property.

Further, the display element preferably includes electric field means which produces an electric field between both of the substrates, preferably substantially perpendicularly to the pair of substrates, more preferably perpendicularly to the pair of substrates (i.e. substrate surface normal direction) and applies an electric field to the substance layer. More specifically, the display element is preferably provided with an electrode on each substrate, for applying an electric field between the substrates. With the arrangement in which the electrode is provided on each of the substrates, it is possible to produce an electric field in the substrate surface normal direction to the substrates. In this arrangement in which the electrode causes the electric field to be produced in the substrate surface normal direction to the substrates, the whole area on the substrate can be utilized as the display region, without sacrificing the area where the electrode is provided. This improves aperture ratio and transmittance, and attains reduction of a driving voltage. Further, with this arrangement, it is possible to promote the exhibition of the optical anisotropy not only in the area of the substance layer that is in the vicinity of the substrates but also in the area which is far from the substrates. Moreover, in terms of a gap across which the driving voltage is applied, it is possible to attain a narrower gap compared with the case of attaining a narrow gap between the comb electrodes.

In the present invention, the dielectric substance layer made of the dielectric substance is preferably used for the substance layer, i.e. the layer, as described previously, containing a liquid crystalline medium exhibiting a nematic liquid crystal phase, and exhibiting optical isotropy when no electric field is applied while exhibiting optical anisotropy when an electric field is applied.

Thus, it is more desirable that for example, a display element according to the present embodiment includes; a pair of substrates which are opposed to each other; a dielectric substance layer sandwiched between the substrates; and electric field applying means for applying an electric field to the dielectric substance layer, the electric field applying means producing an electric filed in a substrate surface normal direction to the substrates, the dielectric substance layer including a liquid crystalline medium exhibiting a nematic liquid crystal phase, and exhibiting an optical isotropy when no electric field is applied, while exhibiting an optical anisotropy when an electric field is applied, wherein: Δn×|Δ∈|≧1.9, where Δn is a refractive index anisotropy at 550 nm in a nematic phase of the liquid crystalline medium exhibiting the nematic liquid crystal phase, and |Δ∈| is an absolute value of a dielectric anisotropy at 1 kHz in the nematic phase of the liquid crystalline medium exhibiting the nematic liquid crystal phase.

With any of the arrangements, when the liquid crystalline medium is a liquid crystalline medium satisfying Δn×|Δ∈|≧1.9, as the driving voltage for the display element, a maximum root-means-square value of a voltage applicable to the substance layer, e.g. the dielectric substance layer can be attained with a manufacturable cell thickness (i.e. thickness of the substance layer (dielectric substance layer).

Especially, when Δn×|Δ∈|≧4.0, it is possible to effectively exhibit optical anisotropy with further lower voltage when an electric field is applied. Setting to Δn×|Δ∈|≧4.0 enables practical use for the display element at a voltage at which the conventional TFT element and general-purpose driver can be driven, without cost increase for drivers and the like.

Therefore, with any of these arrangements, it is possible to realize a display element which can be driven in fast responding speed, with low driving voltage, and within a wider temperature range. Thus, with any of these arrangements, the door is opened to the practical use for such a display element having high-speed response property and wide viewing angle property.

Further, it is preferable that Δn≧0.14 and |Δ∈|≧14. Still further, it is more preferable that Δn≧0.2 and |Δ∈|≧20.

With the above arrangements, it is possible to attain the low-voltage driving without increasing either Δn or |Δ∈| to an extreme. This gives a large freedom to liquid crystal material development.

Further, it is preferable that Δ∈ (dielectric anisotropy of the liquid crystalline medium) is negative. That is, the liquid crystalline medium preferably has a dielectric constant in a direction along the long axis of the molecule lower than that in a direction along the short axis of the molecule (dielectric constant in a direction along the long axis of the molecule<dielectric constant in a direction along the short axis of the molecule).

When an electric field is applied to such a liquid crystalline medium, each molecule changes its orientation to orient in the substrate in-plane direction (direction parallel to the substrate surface). This allows for induction of optical modulation. Thus, as described above, using the liquid crystalline medium of negative Δ∈, enables more efficient exhibition of optical anisotropy upon application of an electric field without loss of an aperture ratio, unlike the arrangement in which a substrate in-place electric field is produced by using a comb electrode.

Still further, it is preferable that the liquid crystal display element has an orientation auxiliary material provided between the substrates, the orientation auxiliary material functioning to promote exhibition of an optical anisotropy by application of the electric field.

As described previously, as to the display element which performs display operation by using a substance (e.g. dielectric substance) exhibiting optical isotropy when no electric field is applied while exhibiting optical anisotropy when an electric field is applied, especially, a substance (e.g. dielectric substance) exhibiting optical anisotropy with the change in orientational direction of the molecules by application of an electric field, there was conventionally the problem that the display element shows high-speed response property and wide viewing angle property, but requires a very high driving voltage.

On the contrary, according to the above arrangement, providing the orientation auxiliary material between the substrates can promote the change in orientation of the molecules in the substance (e.g. dielectric substance) by application of an electric field, thus allowing for more efficient exhibition of optical anisotropy upon application of an electric field. Thus, with the above arrangement, it is possible to cause exhibition of optical anisotropy at a low voltage. Therefore, it is possible to realize a display element that is operable with a driving voltage of a practical level and that has high-speed response property and wide viewing angle property.

The orientation auxiliary material may be formed in the substance (dielectric substance) layer. In this case, the orientation auxiliary material preferably has a structural anisotropy. Further, the orientation auxiliary material preferably formed in a state where the liquid crystalline medium in the substance layer is in a liquid crystal phase. Further, the orientation auxiliary material may be made of polymerizable compound or made of polymer compound. Still further, the orientation auxiliary material may be made of (i) at least one polymer compound selected from the group consisting of a chain polymer compound, a network polymer compound, and a cyclic polymer compound, (ii) hydrogen bonding material, or (iii) porous material.

The above arrangements are preferable for the orientation auxiliary material for promoting exhibition of optical anisotropy by application of an electric field.

The orientation auxiliary material, which is formed in the substance (dielectric substance) layer, can promote orientation of the molecules of the liquid crystalline medium in the substance (dielectric substance). Thus, even if a high voltage is not applied, the orientation regulating force is sufficiently exerted inside the bulk, which realizes a uniaxial orientation.

Especially, with the arrangement in which the orientation auxiliary material has a structural anisotropy, and is made of (i) a polymer compound such as chain polymer compound, a network polymer compound, and a cyclic polymer compound, (ii) hydrogen bonding material, (iii) porous material, or the like, obtained by polymerization of a polymerizable compound, for example, the change in orientational direction of the molecules in the substance constituting the substance layer can be promoted by intermolecular interaction with the orientation auxiliary material. That is, with the above arrangement, the molecules in the substance constituting the substance layer can be easily oriented along the direction regulated by the structural anisotropy of the substance (material) constituting the orientation auxiliary material, by intermolecular interaction with the substance (material) constituting the orientation auxiliary material.

Further, the orientation auxiliary material is made of the aforesaid substance ((material), whereby the orientation auxiliary material exists every-regions in the substance layer. That is, the orientation auxiliary material can be formed over an entire area or substantially entire area of the substance layer. Therefore, the orientation auxiliary material has an excellent orientation regulating force, and can therefore increase the orientational order of the molecules in the liquid crystalline medium in every region of the substance layer. With the above arrangement, it is therefore possible to obtain a greater optical response and a maximum transmittance with a further lower voltage.

Further, especially, since the orientation auxiliary material is formed in a state where the liquid crystalline medium in the substance layer is in a liquid crystal phase, the obtained orientation auxiliary material is directed in a high proportion along the orientational direction of the molecules constituting the liquid crystalline medium, when the liquid crystalline medium is in a liquid crystal phase, i.e. nematic liquid crystal phase. Therefore, with the orientation auxiliary material, it is possible to promote the molecules constituting the liquid crystalline medium so as to be oriented in the same orientational direction as that in the liquid crystal phase upon application of an electric field. As such, it is possible to securely promote the exhibition of optical anisotropy upon application of an electric field.

Still further, especially, in case of using a porous material for the orientation auxiliary material, the porous material layer is formed in the state where only the surfaces of the substrates, which sandwiches the substance layer, are subjected to alignment treatment. This allows the porous material layer (orientation auxiliary material) to grow its anisotropy in a self-organizing manner according to anisotropy of the surfaces of the substrates. Thus, in the case of using the porous material, the orientation auxiliary material is not necessarily formed in the state where the liquid crystalline medium exhibits a liquid crystal phase. This realizes a simplified manufacture process.

Further, the orientation auxiliary material is preferably the one (material) which divides the liquid crystalline medium in the substance layer into small regions. Particularly, the small region preferably has a size of not more than visible light wavelength.

According to the above arrangement, the liquid crystalline medium is kept in the small regions, preferably micro regions each of which is not more than the wavelength of visible light, so that the liquid crystalline medium can exhibit the electro-optical effect (e.g. Kerr effect) caused by application of an electric field in a wide temperature range where the isotropic phase exhibits. In a case where the size of the small region is not more than the wavelength of visible light, it is possible to prevent light diffusion caused by mismatching in refractive index between the orientation auxiliary material, i.e. the material that divides the liquid crystalline medium into small regions, and the liquid crystalline medium. This realizes a high-contrast display element.

Further, the orientation auxiliary material may be a horizontal alignment film which is provided to at least one of the substrates. The horizontal alignment film may be subjected to rubbing treatment or light irradiation treatment. That is, the orientation auxiliary material may be a horizontal alignment film subjected to rubbing treatment or light irradiation treatment. Further, the light irradiation treatment may be polarized light irradiation treatment.

According to the above arrangement, by using the horizontal alignment film as the orientation auxiliary material, orientational direction of the molecules in the vicinities of the surfaces of the horizontal alignment films in the substance layer can be fixed to the substrate in-plane direction. With this arrangement, in the state where the liquid crystalline medium is caused to exhibit the liquid crystal phase, i.e. nematic liquid crystal phase, the molecules (liquid crystal molecules) making up the liquid crystalline medium can be oriented in the substrate in-plane direction. Thus, the orientation auxiliary material can be provided in such a manner that the orientation auxiliary material in a high proportion is oriented along the substrate in-plane direction. With this arrangement, the orientation auxiliary material promotes the liquid crystal molecules making up the liquid crystalline medium to be oriented in the substrate in-plane direction when an electric field is applied. As such, it is possible to reliably and efficiently promote the exhibition of an optical anisotropy when an electric field is applied. Especially, the horizontal alignment films are preferable to attain the object of the present invention of, by using the liquid crystalline medium having a negative Δ∈ (dielectric anisotropy), causing the liquid crystal molecules constituting the liquid crystalline medium to be oriented in the substrate in-plane direction when an electric field is applied. Unlike the vertical alignment films, the horizontal alignment films allow the liquid crystal molecules to be efficiently oriented in the substrate in-plane direction when an electric field is applied, thus causing the liquid crystal molecules to more effectively exhibit the optical anisotropy.

When the horizontal alignment films subjected to alignment treatment such as rubbing treatment or light irradiation treatment are used as the orientation auxiliary material L, the liquid crystal molecules can be aligned in one direction when an electric field is applied. With this, it is possible to further more effectively exhibit the optical anisotropy when an electric field is applied. When the optical anisotropy can be effectively exhibited, it is possible to realize a display element capable of driving at a lower voltage.

It is more preferable that the horizontal alignment film is provided in each of the substrates, and arranged so that rubbing directions in the rubbing treatment or light irradiation directions in the light irradiation treatment are parallel, antiparallel, or orthogonal to each other.

With this arrangement, as in the conventional nematic liquid crystal mode, light utilization efficiency upon application of an electric field increases, which thus improves a transmittance. This makes it possible to carry out a low-voltage driving and to reliably fix the orientational direction of the molecules in the vicinities of the surfaces of the horizontal alignment films in the substance layer to a desired direction. Especially, in this arrangement, the rubbing treatment or the light irradiation treatment is performed in such a manner that the rubbing directions or the light irradiation directions are mutually different. For example, the horizontal alignment films are arranged so that the rubbing directions or the light irradiation directions are orthogonal to each other. This allows the molecules making up the liquid crystalline medium to be oriented so as to form twisted structure when an electric field is applied. That is, the molecules can be oriented so as to form the twisted structure in which the major axis direction of the molecules is directed to the direction parallel to the substance surfaces, and the molecules are oriented so as to be twisted in sequence in the direction parallel to the substrate surfaces from one substrate side to the other substrate side. This makes it possible to alleviate the coloring phenomenon due to wavelength dispersion of the liquid crystalline medium.

Contributory factors to determine the electro-optical property (e.g. voltage-transmittance characteristics) are not only Δn but also the thickness (d) of the material layer (e.g. dielectric material layer). That is, phase difference is determined by the following equation: Δn×d, and this corresponds to transmittance.

In the display element, it is desirable that when the rubbing directions or the light irradiation directions are parallel or antiparallel to each other, the display element satisfies λ/4≦Δn×d≦3λ/4 where d (μm) is a thickness of the substance layer, and λ (nm) is a wavelength of incident light. Further, in the display element, it is desirable that when the rubbing directions or the light irradiation directions are orthogonal to each other, the display element satisfies 350 (nm)≦Δn×d≦650 (nm) where d (μm) is a thickness of the substance layer.

When the rubbing directions or the light irradiation directions are parallel or antiparallel to each other, maximum light utilization efficiency (i.e. maximum transmittance) is attained under the condition where the half-wavelength condition (λ/2) is satisfied in the range of λ/4≦Δn×d≦3λ/4 where the half-wavelength condition is at the center. When the rubbing directions or the light irradiation directions are orthogonal to each other, maximum light utilization efficiency is attained under the condition where 350 (nm)≦Δn×d≦650 (nm). Thus, the display element according to the present invention can improve light utilization efficiency, in addition to the aforesaid effects, by satisfying the above condition as well as the previously-mentioned conditions.

Further, it is preferable that the substance layer further has particulates sealed therein. That is, it is preferable that the substance layer has sealed therein a medium containing particulates.

Further inclusion of particulates in the substance layer, i.e. addition of particulates to the medium in the substance layer can stabilize the orientation (orientational order) of the medium upon application of no electric field.

Further, it is preferable that the substance layer has sealed therein a medium whose refractive index changes proportionately with square of an electric field.

The change in the refractive index proportionately to the square of the electric field applied is advantageous that it realizes a fast responding speed. However not only a very fast responding speed but also unlimited viewing angle is attained in the substance layer made from the medium 11 whose refractive index changes proportionately to the square of the electric field. The very fast responding speed is attained because the orientational direction of the molecules is changeable by the electric field application, thus the respective molecules randomly directed are rotated to change their directions, by controlling localization of electrons in each molecule. The unlimited viewing angle is attained because the molecules are randomly arranged. Thus, according to this arrangement, it is possible to realize a display element having more excellent high-speed response property and wide viewing angle property.

Further, the substance layer may have sealed therein a medium containing polar molecules.

With the above arrangement, the electric field application causes polarization of the polar molecules. The polarization further promotes the orientation of the polar molecules. Thus, it becomes possible to cause the optical anisotropy with a lower voltage. Here, the orientation auxiliary material formed between the pair of the substrates further promotes the orientation of the polar molecules. Thus, it is possible to realize optical anisotropy with lower voltage. This makes it possible to realize voltage reduction in driving voltage.

Further, the substance layer may take a twisted structure with only one chirality. Still further, the substance layer has sealed therein a medium exhibiting chirality.

With the above arrangements, the orientational direction of the molecules of the medium contained in the substance layer can be one chirality, i.e. a twisted structure having either right-handed twist or left-handed twist. Especially, the medium exhibiting chirality sealed in the substance layer securely enables the orientational direction of the molecules to be a twisted structure with only one chirality. With the above arrangements, the molecules constituting the medium can be made to have the twisted structure with either right-handed twist or left-handed twist. This solves the problem of a decreased transmittance at the border of a domain. Such a problem was caused by the arrangement where there exist multidomains taking twisted structures each having both right-handed twist and left-handed twist. Thus, the transmittance is improved. The twisted structures have constant optical activities even when there are no interrelations between the twisted structures in their twist direction. As such, with the above arrangement, the substance layer can exhibit a large optical activity as a whole. Thus, it is possible to attain the maximum transmittance with a low voltage, which allows for lowering a driving voltage to the practical level.

Further, in the case where the substance layer has the medium (chiral agent) exhibiting chirality sealed therein, it is possible to cause intermolecular interaction to the extent of a chiral pitch (spontaneous twist length) of the medium exhibiting chirality inside the isotropic-phase liquid crystalline medium. With this, not only contribution to low-voltage driving, but also exhibition of optical anisotropy in a wider temperature range upon application of an electric field can be realized.

Further, the liquid crystalline medium may have a selective reflection wavelength band or a helical pitch of not more than 400 nm.

When the helical pitch of the liquid crystalline medium is greater than 400 nm, a color corresponding to the helical pitch could be given. A phenomenon of selectively reflecting light having the wavelength reflecting such a helical pitch is called selective reflection. By setting the selective reflection wavelength band or the helical pitch to be not more than 400 nm, it is possible to prevent such a color from being given.

As described above, the display device of the present invention includes the foregoing display element according to the present invention. Thus, according to the present invention, it is possible to attain a display device which realizes a high response speed, a low driving voltage, and driving in a wide temperature range.

The present invention is not limited to the description of the embodiments above, but may be altered by a skilled person within the scope of the claims. An embodiment based on a proper combination of technical means disclosed in different embodiments is encompassed in the technical scope of the present/invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The display device of the present invention can be widely used for an image display apparatus such as a television and a monitor, an OA (Office Automation) apparatus such as a word processor and a personal computer, and an image display device provided in an information terminal such as a video camera, a digital camera, and a mobile phone.

1. A display element, comprising:
a pair of substrates which are opposed to each other; and
a substance layer sandwiched between the substrates,
the display element performing display operation by applying an electric field to between the substrates,
the substance layer including a liquid crystalline medium exhibiting a nematic liquid crystal phase, and exhibiting an optical isotropy when no electric field is applied, while exhibiting an optical anisotropy when an electric field is applied,
wherein:
Δn×|Δ∈|≧1.9,
where Δn is a refractive index anisotropy at 550 nm in a nematic phase of the liquid crystalline medium exhibiting the nematic liquid crystal phase, and |Δ∈| is an absolute value of a dielectric anisotropy at 1 kHz in the nematic phase of the liquid crystalline medium exhibiting the nematic liquid crystal phase.

2. The display element according to claim 1, wherein:
Δn≧0.14 and |Δ∈|≧14.

3. The display element according to claim 1, wherein:
Δn×|Δ∈|≧4.0.

4. The display element according to claim 3, wherein:
Δn≧0.2 and |Δ∈|≧20.

5. The display element according to claim 1, wherein:
Δ∈ is negative.

6. The display element according to claim 1, wherein:
an orientation auxiliary material is provided between the substrates, the orientation auxiliary material functioning to promote exhibition of an optical anisotropy by application of the electric field.

7. The display element according to claim 6, wherein:
the orientation auxiliary material is formed in the substance layer.

8. The display element according to claim 7, wherein:
the orientation auxiliary material has a structural anisotropy.

9. The display element according to claim 7, wherein:
the orientation auxiliary material is formed in a state where the liquid crystalline medium in the substance layer is in a liquid crystal phase.

10. The display element according to claim 7, wherein:
the orientation auxiliary material is made of a polymerizable compound.

11. The display element according to claim 7, wherein:
the orientation auxiliary material is made of a polymer compound.

12. The display element according to claim 11, wherein:
the orientation auxiliary material is made of at least one polymer compound selected from the group consisting of a chain polymer compound, a network polymer compound, and a cyclic polymer compound.

13. The display element according to claim 7, wherein:
the orientation auxiliary material is made of hydrogen bonding material.

14. The display element according to claim 7, wherein:
the orientation auxiliary material is made of porous material.

15. The display element according to claim 7, wherein:
the orientation auxiliary material divides the liquid crystalline medium in the substance layer into small regions.

16. The display element according to claim 15, wherein:
the small region has a size of not more than a visible light wavelength.

17. The display element according to claim 7, wherein:
the orientation auxiliary material is a horizontal alignment film which is provided in at least one of the substrates.

18. The display element according to claim 17, wherein:
the horizontal alignment film is subjected to rubbing treatment or light irradiation treatment.

19. The display element according to claim 18, wherein:
the horizontal alignment film is provided in each of the substrates, and is arranged so that rubbing directions in the rubbing treatment or light irradiation directions in the light irradiation treatment are parallel or antiparallel to each other.

20. The display element according to claim 19) wherein:
said display element satisfies λ/4≦Δn×d≦3λ/4 where d (μm) is a thickness of the substance layer, and λ(nm) is a wavelength of incident light.

21. The display element according to claim 18, wherein:
the horizontal alignment film is provided in each of the substrates, and is arranged so that rubbing directions in the rubbing treatment or light irradiation directions in the light irradiation treatment are orthogonal to each other.

22. The display element according to claim 21, wherein:
said display element satisfies 350 (nm)≦Δn×d≦650 (nm) where d (μm) is a thickness of the substance layer.

23. The display element according to claim 1, wherein:
the substance layer further includes particulates sealed therein.

24. (canceled)

25. The display element according to claim 1, wherein:
the substance layer has sealed therein a medium containing polar molecules.

26. The display element according to claim 1, wherein:
the substance layer takes a twisted structure with only one chirality.

27. The display element according to claim 1, wherein:
the substance layer has sealed therein a medium exhibiting chirality.

28. The display element according to claim 1, wherein:
the liquid crystalline medium has a selective reflection wavelength band or a helical pitch of not more than 400 nm.

29. (canceled)

30. (canceled)

31. A display device including the display element according to claim 1.
